(19) United States
(12) Patent Application Publication
(10) Pub. No.: US 2014/0109617 A1
(43) Pub. Date: Apr. 24, 2014

(54) SYSTEMS AND METHODS FOR PROCESSING LEAD-CONTAINING GLASS

(71) Applicants: Svitlana Grigorenko, Montreal (CA); Andre Brosseau, Montreal (CA)

(72) Inventors: Svitlana Grigorenko, Montreal (CA); Andre Brosseau, Montreal (CA)

(73) Assignee: Greene Lyon Group, Inc., Amesbury, MA (US)

(21) Appl. No.: 14/007,840

(22) PCT Filed: Mar. 29, 2012
(86) PCT No.: PCT/US12/31288

§ 371 Date: Dec. 6, 2013

Related U.S. Application Data
(60) Provisional application No. 61/468,931, filed on Mar. 29, 2011.

(51) Int. Cl. C03C 23/00

(52) U.S. Cl. CPC C03C 23/008
USPC 65/31; 65/181

(57) ABSTRACT

Systems and methods for processing lead-containing glass are generally described. In certain embodiments, at least a portion of the lead within the bulk of the lead-containing glass is removed from the lead-containing glass and transferred to a liquid leaching medium. Removal of lead from the bulk of the lead-containing glass, as opposed to the surface and areas closely adjacent to the surface of the lead-containing glass, can allow for the production of recycled glass that includes substantially no lead within its boundaries.

### RELATED APPLICATIONS

This application claims priority under 35 U.S.C. §119(e) to U.S. Provisional Patent Application Ser. No. 61/468,931, filed Mar. 29, 2011, and entitled “Method and Apparatus for the Recycling of Obsolete Electronic Equipment Containing Lead Glass,” which is incorporated herein by reference in its entirety for all purposes.

### TECHNICAL FIELD

Systems and methods for processing lead-containing glass are generally described. Certain embodiments relate to processes for recycling waste electronic equipment containing lead glass. In some embodiments, systems and methods for the chemical removal of lead from lead-containing glass are described. Certain embodiments relate to the processing of electronics into useful recycled material fractions in an environmentally acceptable manner.

### BACKGROUND

Cathode ray tubes (CRTs), found mainly in television sets and computer monitors, are one of the largest contributors to electronic waste. CRTs are considered hazardous waste mainly due to the high lead content of the glass. Two major approaches to the recycling of CRT tubes are known: the Glass-to-Glass and the Glass-to-Lead recycling processes. Crushed CRT glass can also be used in the production of bricks, ceramic tiles, and the like, which generally involve the separation of the waste into two types of glass, leaded and non-leaded, and utilization of only the non-leaded glass.

Glass-to Glass recycling, which generally involves re-utilization of waste lead glass in the production of new CRTs, is generally no longer practiced as CRT manufacturing has been largely replaced by the manufacture of non-CRT displays, including liquid crystal displays. Glass-to-Lead recycling generally involves re-processing of CRT glass into lead, for example, using lead smelters. There are few smelters in North America that accept CRT glass. Generally, this method of recycling is not profitable for recyclers as they have to pay processing fees. Moreover, smelting of lead glass is not considered an environmentally-friendly option because lead, being a low-temperature volatile component, can escape relatively easily from the process, evaporating and creating toxic gaseous emissions to the atmosphere. In view of the above, there is a strong need for an alternative method of recycling CRT glass and other lead-containing glasses that would be safe for the environment and profitable for recyclers.

One safer and cheaper alternative to the processes outlined above involves the chemical leaching of the lead-containing glass. Lead is usually incorporated in the glass structure in the form of lead oxide (II). Accordingly, leaching of lead glass with substances which are generally used for dissolving of lead oxide can be advantageous.

Additionally, Sasai, et al. (“Development of an Eco-Friendly Material Recycling Process for Spent Lead Glass Using a Mechanochemical Process and Na₂EDTA Reagent,” Environ. Sci. Technol., 42, 4159-4164, 2008 describe a process where lead is removed from glass during a high energy wet ball-milling process. The Sasai et al. process is believed to be similar to low-temperature alloying. The high energy, which is released by the impacts of grinding media is described as inducing a solid state chemical reaction between the glass and the chelating agent Na₂EDTA. As a result of this process, a relatively fine silica powder, including particles with cross-sectional diameters of less than 1 micrometer is obtained, which is than rinsed with water under apparently acidic conditions. The conditions outlined in Sasai et al. appear to only be suitable for removal of lead from the surface of glass particles. In addition, The Sasai process appears to require that a milling process be performed during lead extraction, which is commercially impractical for many applications as it requires very long treatment times (e.g. 20 hrs.) and high energy consumption.

Chemical leaching is also exploited, for example, in U.S. Pat. No. 6,666,904 (“the '904 patent”) and U.S. Pat. No. 6,669,757 (“the '757 patent”). These patents teach the extraction of metals from glass waste by crushing the glass and bringing it into contact with a solution of water and an acid, whereby the metal is leached in acidic solution from the surface of glass particles. The methods outlined in these patents generally leach the lead glass using aqueous solutions of acids such as nitric acid (HNO₃), hydrochloric acid (HCl), and phosphoric acid (H₃PO₄). Although nitric acid is well-known for its ability to dissolve lead oxide, the other acids have only moderate lead leaching abilities. Moreover, both hydrochloric and phosphoric acids form insoluble salts of lead, which are generally mixed with the treated glass in the above-described processes. Neither of the '904 patent and the '757 patent proposes a method of separating these metallic salts from the milled glass. The only acid of the above-mentioned acids that can efficiently extract lead while also forming a soluble salt of lead in processes including the separation of leached metal from glass cullet is the nitric acid, which is a strong oxidizing agent and is generally dangerous for the environment.

In addition, the processes outlined in the '904 patent and the '757 patent have various disadvantages. For example, the process outlined in the '904 patent is generally slow. According to the '904 patent, the leaching process is performed by circulating a slurry mixture within a leaching tank using a slurry pump. In the process described in the '904 patent, the leaching time is about at least 2 hours (6 hours in one embodiment). After the separation of glass particles from the leaching medium, the glass generally needs to be water-rinsed by mixing, which takes an additional hour. The long leaching times and low intrinsic value of the final product make it unlikely that such a process would be economically advantageous.

In the '757 patent, leaching times are claimed to be shorter as leaching takes place by elevated temperatures using 10 nm sized glass particles. However, reduction of glass particles down to nanometre-size ranges and the usage of hot liquids consumes a large amount of energy. Moreover, producing nanometer-scale lead glass is environmentally dangerous because lead containing nanoparticles can be expected to be directly absorbed by the human body.

Neither the '904 patent nor the '757 patent provides information regarding the final lead concentrations in the treated glass. Therefore, it is unclear whether these processes produce de-leaded glass that can pass the Toxicity Characteristic Leaching Procedure (TCLP) (see reference provided for this procedure provided below).

For at least the reasons outlined above, there is still a strong need for a more efficient, safe, and cost-effective method for lead extraction from lead-containing glasses, including CRT glasses, which does not require the application of harsh chemicals.

### SUMMARY

Systems and methods for processing lead-containing glass are generally described. In certain embodiments, at least a portion of the lead within the bulk of the lead-containing glass is removed, for example, using lead-complexing agents such as chelating agents. Inventive systems configured to break down whole pieces of electronic equipment and process glass components are also described. The subject matter of the present invention involves, in some cases, interrelated products, alternative solutions to a particular problem, and/or a plurality of different uses of one or more systems and/or articles.

In some embodiments, new methods for the recycling of waste television sets, monitors, cathode ray tubes and other sorts of waste electronic equipment, which contain parts made of lead glass, are provided.

In some embodiments, cavitation is created within a liquid leaching medium when the leaching medium is exposed to the lead-containing glass. Cavitation can be created, for example, by using acoustic energy, for example, in the form of ultrasonic waves. Accordingly, in one set of embodiments, a method for sonochemical leaching of lead-containing glass (including CRT glass, crystal glass, etc.), which comprises chemical leaching of lead glass (optionally, milled lead glass) under the application of ultrasound. Cavitation (e.g., created by ultrasound, or by any of the other methods described herein) can result in significant intensification of the leaching reaction, which can provide faster extraction of lead in larger quantities and in shorter times than can be achieved by leaching in the absence of cavitation but under otherwise essentially identical conditions.

In some embodiments, a method for recovering lead, which can be present in the lead glass in the form of lead oxide (II), is described. In certain embodiments, after having been dissolved in the leaching solution, lead can be recovered by a variety of methods such as, for example, by being precipitated in the form of one of its insoluble salts or its hydroxide, by being recovered on ionic exchange resins, and/or by electrowinning.

In one set of embodiments, an essentially lead-free recycled glass is provided. The lead-free recycled glass, which can be a product of any of the processes described herein, can satisfy the requirements of non-toxicity and demonstrates safe amounts of leached lead when subjected to the EPA's standard Toxicity Characteristic Leaching Procedure (TCLP). In some embodiments, the recycled glass can be used as a safe admixture to cement, as silica flour, in road construction, in sandblasting, in brick making, and/or in a variety of other applications.

Still another set of embodiments of the invention relates to providing a safe and environmentally-friendly process for recycling electronic equipment such as CRTs, TVs, and/or any other sort of lead glass containing waste. The processes described herein can be configured such that they do not create substantial amounts of toxic fumes, in contrast to many standard recycling processes based on glass smelting. Certain of the methods of lead glass leaching described herein employ very mild chemicals, and the leaching medium can be recycled and re-used, for example, in a closed loop process. In certain embodiments, neither waste effluents nor additional solid wastes are generated.

Still another set of embodiments of the invention relates to providing a cost-effective method for recycling lead-containing glass. Certain processes described herein do not require high energy consumption, as elevated temperatures and pressures are not employed. The upfront separation of lead and non-lead glass, which is a feature of certain methods described herein, can allow one to reduce the volume of treated glass, which can reduce operating cost. The recovered lead and the lead-free glass (as well as the other recycled material fractions such as copper degaussing coils, plastics, steel, and the like) can be sold.

Still another set of embodiments relates to an automated lead-containing glass recycling system (e.g., a fully-automatic recycling system), which can employ minimal manual labour. Certain such recycling systems can be utilized as an alternative to existing recycling practises, which generally utilize manual dismantling of old devices, manual separation of panel and funnel glass components, manual suction of phosphorous coatings, and the like. In contrast, according to certain embodiments, old monitors, CRTs and TV units are mechanically crushed, phosphors are partially captured by a dedusting system and partially washed out by a leaching liquid, and/or panel and funnel glass components are separated automatically by an optical sorter system.

In aspects of the invention, methods of extracting lead from a lead-containing glass are disclosed. In certain embodiments, the method comprises: exposing a plurality of lead-containing glass particles to a liquid leaching medium comprising a lead-complexing agent, such that the lead-complexing agent associates with at least a portion of the lead from within the bulk of the lead-containing glass to facilitate transport of the lead to the liquid leaching medium to produce treated glass; and separating at least a portion of the treated glass particles from at least a portion of the liquid leaching medium, wherein, throughout the exposing step, at least about 50% of the total volume of the glass particles is made up of glass particles having a minimum cross-sectional dimension of at least about 2 micrometers.

In certain embodiments, the method comprises: exposing the lead-containing glass to a liquid leaching medium comprising a lead-complexing agent, such that the lead-complexing agent associates with at least a portion of the lead from within the bulk of the lead-containing glass to facilitate transport of the lead to the liquid leaching medium to produce treated glass, wherein, the lead-containing glass is not substantially reduced in size during the exposing step; and separating at least a portion of the treated glass from at least a portion of the liquid leaching medium.

In certain embodiments, the method comprises: exposing the lead-containing glass to a liquid leaching medium comprising a lead-complexing agent, wherein the liquid leaching medium has a pH of at least about 8; transporting at least a portion of the lead from within the bulk of the lead-containing glass to the liquid leaching medium to produce treated glass; and separating at least a portion of the treated glass from at least a portion of the liquid leaching medium.

In certain embodiments, the method comprises: exposing the lead-containing glass to a liquid leaching medium, such that at least a portion of the lead within the bulk of the lead-containing glass is transported to the liquid leaching medium to produce treated glass; creating cavitation within the liquid leaching medium during at least a portion of the time during which the lead-containing glass is exposed to the liquid leaching medium; and separating at least a portion of the treated glass from at least a portion of the liquid leaching medium.

Another aspect of the invention involves systems for extracting lead from lead-containing glass. In certain embodiments, the system comprises: a treatment stage configured to expose lead-containing glass material to a liquid leaching medium, wherein the system containing the liquid leaching medium is able to treat a substantially spherical lead-containing glass particle having a cross-sectional diameter of at least about 2 micrometers by exposing it to the liquid leaching medium, such that substantially all of the lead is removed from the glass particle.

Another aspect of the invention involves an integrated system configured for recycling electronic equipment comprising leaded glass. In certain embodiments, the system comprises: a first stage in which a substantially intact piece of electronic equipment comprising glass components and non-glass components is disaggregated to produce glass components and non-glass components; a second stage in which at least a portion of the glass components are separated from at least a portion of the non-glass components, wherein at least a portion of the glass components comprise lead-containing glass; and a third stage comprising a liquid leaching medium able to extract at least a portion of the lead from the lead-containing glass.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a cross-sectional schematic diagram of a piece of lead-containing glass, according to one set of embodiments.

FIG. 2 is a schematic diagram of a recycling process for treating components comprising lead-containing glass, according to certain embodiments.

FIG. 3 shows a flowchart illustrating a glass treatment process in which whole TVs, computer monitors, and CRTs are used as input materials, and in which a glass sorter is used to separate the glass fraction, according to one set of embodiments.

FIG. 4 shows, according to certain embodiments, a flowchart illustrating a glass treatment process in which whole TVs, computer monitors, and CRTs are used as input materials, and in which a sorter is used to separate the glass fraction and to separate other material fractions.

FIG. 5 shows, according to some embodiments, a flowchart illustrating a glass treatment process in which CRTs and/or mixed glass is used as the input material.

FIG. 6 is a flowchart illustrating a glass treatment process in which mixed lead and non-lead glass are treated, in which a glass sorter is used to separate the incoming glass flow into lead-glass, non-lead glass, and frit glass fractions, and wherein the frit glass fraction consists of pieces of lead and non-lead glass, connected by a frit line, according to certain embodiments.

FIG. 7 is a flowchart illustrating the use of sonochemical leaching with recovery of lead carbonate, according to some embodiments.

FIG. 8 is, according to some embodiments, a flowchart illustrating the use of sonochemical leaching using ion-exchange resins for lead recovery.

FIG. 9 is, according to one set of embodiments, a flowchart illustrating the use of sonochemical leaching using the chelating agent EDTA, the recovery of lead, and the recycling of the leaching medium by electrowinning.

FIG. 10 is a flowchart illustrating the use of sonochemical leaching using chelating agent EDTA and the recovery of the lead compound by chemical precipitation.

### DETAILED DESCRIPTION

Systems and methods for processing lead-containing glass are generally described. In certain embodiments, at least a portion of the lead within the bulk of the lead-containing glass is removed from the lead-containing glass and transferred to a liquid leaching medium. Removal of lead from the bulk of the lead-containing glass, as opposed to the surface and areas closely adjacent to the surface of the lead-containing glass, can allow for the production of recycled glass that includes substantially no lead within its boundaries.

Lead can be removed from the bulk of the glass, for example, by exposing the lead-containing glass to a liquid leaching medium comprising a lead-complexing agent such as a chelating agent. In certain embodiments, the liquid leaching medium can be basic, for example, having a pH of at least about 8, when it is exposed to the lead-containing glass. In certain embodiments, one or more buffering agents are employed to maintain the pH of the liquid leaching medium at a desired level. The buffering agent can be basic or acidic.

Generally, the “bulk” of a piece of material (e.g., a piece of lead-containing glass) refers to the portion of the material piece that is located at least about 750 nanometers from the exterior surface of the piece of material. Accordingly, removal of lead from the bulk of a piece of lead-containing glass generally involves the removal of at least a portion of the lead that is located at least 750 nanometers from the exterior surface of the piece of lead-containing glass. In certain embodiments, lead can be removed from deeper portions of the lead-containing glass, as described in more detail below.

In some embodiments, cavitation can be created within the liquid leaching medium when the leaching medium is exposed to the lead-containing glass. For example, fast extraction of lead from lead glass can be achieved when a high intensity ultrasonic irradiation or any other method of creating cavitation in the leaching medium is employed in combination with the chemical action of a lead-binding agent and/or a chemical that is capable of chemically interacting with lead atoms from the lead-containing glass matrix. The utilisation of ultrasound-assisted chemical leaching can allow for fast and efficient lead recovery at ambient temperatures and pressures using low concentrations of chemicals.

It has been unexpectedly discovered that, by using the systems and methods described herein, lead can be extracted from the bulk of lead-containing glass, including at depths of greater than 1 micrometer from the surface of the lead-containing glass. The ability to extract bulk lead sharply contrasts with prior art systems, in which lead is generally exclusively removed from the lead-containing glass at or near the exposed surface(s) of the glass. The ability to remove lead from the bulk of lead-containing glass can allow substantially complete lead extraction from lead-containing glass to be achieved, according to certain embodiments. In certain embodiments, the treated glass has negligible residual lead concentration as determined, for example, by x-ray fluorescence (XRF) analysis (e.g., see www.epa.gov/region4/sesd/fbqstp/Field-XRF-Measurement.pdf) and/or by EPA Method 3052 (www.epa.gov/osw/hazard/testmethods/sw846/pdfs/3052.pdf).

Certain inventive systems are configured to break down whole pieces of electronic equipment and process glass components. In certain embodiments, an automated recycling system is configured to recycle electronic equipment including, but not limited to, television sets, computer monitors, and/or other electronic equipment comprising cathode ray tubes. Certain inventive systems and methods include one or more of the following steps: separation of valuable material fractions, separation of lead glass from non-lead glass, chemical recovery of lead from lead glass, and generation of unleachable glass fraction. In certain embodiments. the total lead content in the treated glass can be substantially reduced relative to the amount of lead present in the untreated glass sample. In certain embodiments, the systems and methods described herein can be configured such that the treated glass can pass the U.S. Environmental Protection Agency's Toxicity Characteristic Leaching Procedure (TCLP) (Method 1311, U.S. Environmental Protection Agency, date issued: Jul. 1, 1992, as revised April, 2008, described at: www.epa.gov/osw/hazard/testmethods/sw846/pdfs/1311.pdf). To pass TCLP for lead content means to have the concentration of lead in the leaching solution, which was exposed to the glass according to the procedure, in the amount less than 5 mg/L.

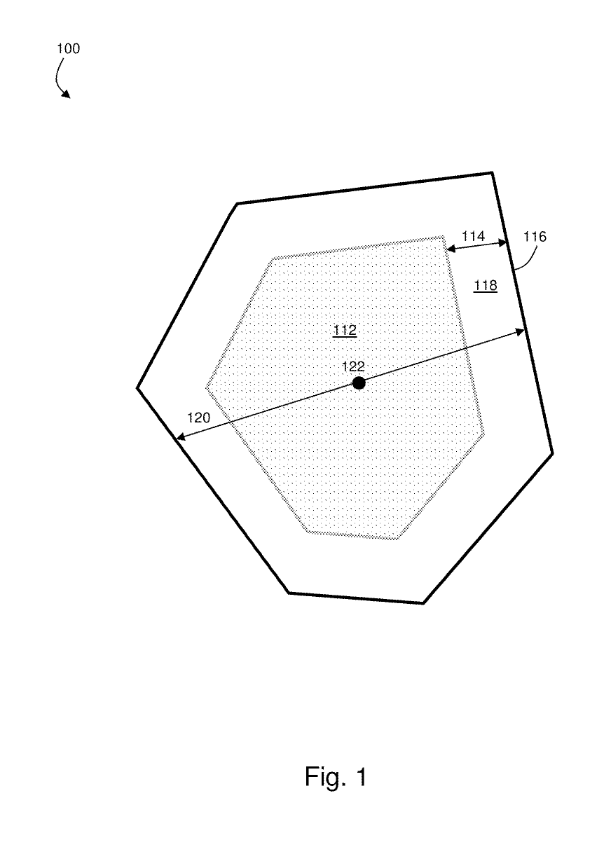

Certain embodiments of the invention relate to methods for recycling lead glass by using a low environmental impact wet processes, which can allow for the recovery of the lead content of waste glass in the form of chemical compounds, which can be convertible to lead oxide (e.g., substantially pure lead oxide). Certain embodiments of the invention present greener and/or cheaper ways to process lead-containing glass for lead extraction, compared to traditional smelting and other glass recycling processes. FIG. 1 is a cross-sectional schematic diagram of a piece 100 of lead-containing glass from which lead is extracted, according to certain embodiments of the invention. While the lead-containing glass in FIG. 1 is illustrated as a particle, it should be understood that lead can be extracted from lead-containing glass of any shape or size. Lead-containing glass 100 can originate from any suitable source. For example, in certain embodiments, the lead-containing glass can be all or part of a cathode ray tube, for example, from a television, a computer monitor, or any other piece of electronic equipment. In certain embodiments, the lead-containing glass can originate from drinkware comprising lead-containing glass. The lead-containing glass can originate, in certain embodiments, from shielding glass, for example, of the type used to shield technicians from x-rays and other forms of radiation in medical/scientific/nuclear applications. One of ordinary skill in the art would be capable of identifying a variety of additional types of suitable lead-containing glass that could be used in the systems and methods described herein.

In certain embodiments, the lead-containing glass comprises lead located within the bulk of the glass, in addition to or in place of lead present on the surface of the lead-containing glass. For example, in FIG. 1, lead-containing glass 100 contains lead within bulk region 112, which is positioned at a depth of indicated by dimension 114, relative to exterior surface 116. Lead-containing glass 100 can also comprise lead within region 118 near exterior surface 116 and/or on exterior surface 116. In some such embodiments, lead can be present at a depth of at least about 1 micrometer or at least about 10 micrometers, relative to the exterior surface of the lead-containing glass. For example, in certain embodiments, dimension 114 in FIG. 1 can be at least 1 micrometer or at least 10 micrometers.

The lead containing glass can include lead in a relatively large amount, in certain embodiments. For example, in some embodiments, prior to treatment of the lead-containing glass (e.g., by exposing the glass to a liquid leaching medium) lead is present within the glass (including lead on the exterior surface and the lead within the bulk of the glass) in an amount of at least about 2 wt %, at least about 5 wt %, at least about 10 wt %, or at least about 20 wt %. In certain embodiments, the lead within the bulk of the lead-containing glass can be substantially evenly distributed throughout the bulk of the glass.

One of ordinary skill in the art would be capable of determining the weight percentage of lead within a given sample of lead containing glass, for example, using EPA test method 3052, which is incorporated herein by reference in its entirety for all purposes. EPA test method 3052 generally involves dissolving the glass sample such that all components of the glass sample can be chemically analyzed to determine their chemical identity. The amount of lead present in an untreated sample can be determined by dissolving a sample of the untreated glass and measuring the mass of lead present in the dissolved glass sample. The mass percentage of lead in the untreated sample can then be calculated as:

$$\% Lead = \frac{Mass of lead in dissolved sample}{Mass of untreated glass sample} \times 100 \%$$

Lead can be present in the lead-containing glass in any suitable form. For example, in certain embodiments, lead is present in the form of a lead oxide, such as lead (II) oxide. In some embodiments, lead can be present in the form of metallic lead and/or in the form of one or more lead salts.

In certain embodiments, the lead-containing glass from which lead is extracted is made up of a plurality of particles. Such particles can be formed, for example, by milling, grinding, or otherwise reducing in size a larger piece of glass such as, for example, a cathode ray tube, a piece of leaded drinkware, or any other suitable type of lead-containing glass. In certain embodiments, the systems and methods described herein can be used to remove lead from lead-containing glass particles of relatively large size. For example, in certain embodiments, the lead-containing glass from which lead is removed comprises a plurality of particles, and at least about 50%, at least about 75%, at least about 90%, at least about 95%, or at least about 99% of the total volume of the glass particles is made up of glass particles having minimum cross-sectional dimensions of at least about 2 micrometers, at least about 10 micrometers, and/or up to about 100 micrometers, up to about 500 micrometers, and/or up to about 1 millimeter. The total volume of a plurality of particles can be calculated as the sum of the individual volumes of the particles and can be determined by measuring the volume of a liquid that is displaced when the particles are submerged in the liquid. The volume of individual particles can be determined using a similar method, or, in the case of small particles, by examining magnified images of the particles using, for example, a scanning electron microscope. As used herein the “minimum cross-sectional dimension” of a particle corresponds to the smallest dimension that extends through the geometric center of the particle and spans two points on the outer boundary of the particle. For example, in FIG. 1, the smallest cross-sectional dimension of glass 100 corresponds to dimension 120, which extends through geometric center 122 of glass material 100.

In certain embodiments, a relatively large amount of the lead within the bulk of the lead-containing glass can be extracted even when relatively large particle sizes are employed, including any of the size distributions mentioned herein. Such large particles are particularly suitable for certain systems and methods described herein due to the ability of said systems and methods to remove lead from the bulk of the particles. Removing lead from the bulk of the particles can be advantageous as it prevents unwanted release of lead from the particles after they are subsequently reduced in size. Subsequent reduction in size might occur, for example, when such particles are disposed of in a landfill or other waste stream which could expose the particles to accidental grinding/weathering that results in a reduction of particle size. By removing lead from the bulk of such particles, any subsequent reduction in size (whether desired or undesired) does not result in the exposure of lead at the surface of the newly formed particle, as might be observed in systems that remove lead only from the surface of such particles including many acid treatment systems.

Lead can be extracted from the lead-containing glass by exposing the lead-containing glass to a liquid leaching medium. The lead-containing glass can be contacted with the liquid leaching medium via any suitable mechanism. For example, in certain embodiments, the liquid leaching medium and the lead-containing glass can be disposed within a vessel in which they make contact with each other. In some embodiments, the liquid leaching medium can be washed over the lead-containing glass. Optionally, the liquid leaching medium can be stirred and/or otherwise agitated to enhance the degree to which the liquid leaching medium interacts with the lead-containing glass and/or the degree to which leached lead is transported away from the lead-containing glass.

In certain embodiments, the lead-containing glass is not substantially reduced in size during the step of exposing the lead-containing glass to the liquid leaching medium. As noted elsewhere, many previous lead removal systems are effective in removing lead substantially only from the exterior surface of and/or regions close to the exterior surface (e.g., within about 500 nm of the exterior surface) of the lead-containing glass. In many such systems, in order to achieve a high degree of lead removal, the lead-containing glass is reduced in size (e.g. via milling, grinding, or a variety of other procedures) during the step of exposing the lead-containing glass to the liquid leaching medium. In contrast, certain systems and methods described herein are capable of removing lead from the bulk of the lead-containing glass, and therefore can remove a high degree of lead even from relatively large particles, which can render the need to reduce the size of lead-containing glass particles unnecessary.

The liquid leaching medium can comprise a lead-complexing agent, in certain embodiments. Lead-complexing agents are components that interact (e.g., via a covalent bond(s), an ionic bond(s), van der Waals interaction, electrostatic interaction, and the like) with lead (in ionic or non-ionic form) to form complexes. Accordingly, lead-complexing agents can be used as vehicles for lead removal, in certain embodiments. In certain embodiments, it is believed that the lead-complexing agent contacts at least a portion of the lead within the bulk of the lead-containing glass. In some embodiments, at least a portion of the lead within the bulk of the lead-containing glass is transported to the liquid leaching medium (e.g., via convection and/or diffusion) to produce treated glass.

The complexing agent comprises, in some embodiments, one or more chelating agents. Chelating agents are known to those of ordinary skill in the art, and are ions or molecules that bind to a central metal atom to form a coordination complex. “Chelate” is used herein to refer to the molecular entity formed when the chelating agent associates with the central metal atom. The association between the central metal atom and the ligand molecules can include one or more covalent bonds, one or more ionic bonds, and/or one or more coordinate covalent bonds. In certain embodiments, it is believed that the chelating agent contacts at least a portion of the lead within the bulk of the lead-containing glass to form a chelate. In certain embodiments, at least a portion of the chelate is transferred from the bulk of the glass to the liquid leaching medium to produce treated glass.

A variety of chelating agents can be used in association with the systems and methods described herein. Examples of suitable chelating agents that can be used in the liquid leaching medium include, but are not limited to, β-diketonate compounds such as acetylacetonate, 1,1,1-trifluoro-2,4-pentanedione, and 1,1,1,5,5,5-hexafluoro-2,4-pentanedione; carboxylates such as formate and acetate and other long chain carboxylates; amides, such as bis(trimethylsilylamide)tetramer; amines and amino acids (e.g., glycine, serine, proline, leucine, alanine, asparagine, aspartic acid, glutamine, valine, and lysine); citric acid; acetic acid; maleic acid; oxalic acid; malonic acid; succinic acid; phosphonic acid, phosphonic acid derivatives such as hydroxyethylidene diphosphonic acid (HEDP), 1-hydroxyethane-1,1-diphosphonic acid, nitrilo-tris(methylenephosphonic acid), nitrilotriacetic acid, iminodiacetic acid, etidronic acid, ethylenediamine, ethylenediaminetetraacetic acid (EDTA), and (1,2-cyclohexylenedinitrilo)tetraacetic acid (CDTA); uric acid; tetraglyme; pentamethyldiethylenetriamine (PMDETA); 1,3,5-triazine-2,4,6-thithiol trisodium salt solution; 1,3,5-triazine-2,4,6-thithiol triammonium salt solution; sodium diethyldithiocarbamate; disubstituted dithiocarbamates (R¹(CH₂CH₂O)₂NR²CS₂Na) with one alkyl group (R₂=hexyl, octyl, deceyl or dodecyl) and one oligoether (R¹(CH₂CH₂O)₂, where R¹=ethyl or butyl); ammonium sulfate; monoethanolamine (MEA); Dequest 2000; Dequest 2010; Dequest 2060s; di ethyl enetriamine pentaacetic acid; propylenediamine tetraacetic acid; 2-hydroxypyridine 1-oxide; ethyl endiamine disuccinic acid (EDDS); N-(2-hydroxyethyl)iminodiacetic acid (HEIDA); dimercaptosuccinic acid (DMSA); nitrilotriacetic acid (NTA); 2-Hydroxyethyl)ethylenediaminetriacetic acid (HEDTA); diethylene triamine pentaacetic acid (DTPA); sodium triphosphate penta basic; and/or sodium and ammonium salts thereof; ammonium chloride; sodium chloride; lithium chloride; potassium chloride; and/or ammonium sulfate. In certain embodiments, it is preferred that the liquid leaching medium comprise at least one phosphonic acid derivative. In some such embodiments, it is preferred that the liquid leaching medium comprise ethylenediaminetetraacetic acid (EDTA). In certain embodiments, the liquid leaching medium comprises acetic acid. In certain embodiments, the liquid leaching medium is substantially free of strong acids. In some embodiments, the liquid leaching medium is substantially free of nitric acid. The liquid leaching medium can be substantially free of hydrochloric acid, in certain embodiments. In some embodiments, the liquid leaching medium is substantially free of sulfuric acid.

In certain embodiments, cationic exchange resins can be used as chelating agents.

One of ordinary skill in the art would be capable of selecting a chelating agent suitable for removing lead from a given sample of lead-containing glass using no more than routine experimentation, for example by performing the following screening test. A lead-containing glass sample can be exposed to a liquid leaching medium containing a candidate chelating agent until the concentration of the lead within the liquid leaching medium stabilizes. After exposing the lead-containing glass sample to the leaching medium, the residual lead content of the glass sample can be determined using EPA test method 3052. If the amount of residual lead is higher than the desired amount, the chelating agent can be eliminated from consideration. On the other hand, if the amount of residual lead is equal to or lower than the desired amount, the chelating agent can be identified as potentially suitable for use.

In certain embodiments, the liquid leaching medium can have a basic pH. For example, in some embodiments, the pH of the liquid leaching medium can have a pH of at least about 8, at least about 10, and/or up to a pH of about 14 (e.g., from a pH of about 8 to a pH of about 14 or from a pH of about 10 to a pH of about 14).

Without wishing to be bound by any particular theory, it is believed that exposure of lead-containing glass to a liquid leaching media having a basic pH can cause modification of silicon-oxygen bonds within the glass, which can make it easier for lead-complexing agents to diffuse into the glass to form complexes with lead ions and/or diffuse out of the glass once the complexes have been formed.

In certain embodiments, the liquid leaching medium can comprise hydroxide ions (i.e., OH—). Without wishing to be bound by any particular theory, it is believed that hydroxide ions can be particularly reactive with silicon oxide materials, for example, forming a gel-like material upon interacting with silicon oxide. Formation of this material is believed to enhance the degree to which complexing agents are able to diffuse through the glass matrix and interact with the lead within lead-containing glass, above and beyond the degree to which these mechanisms are enhanced in the presence of a leaching medium that is basic but does not include hydroxide ions.

In certain embodiments, the chelating agent is able to chelate silicon and other metals present in the glass to at least some extent, which can lead to the release of lead atoms from the glass matrix.

In certain embodiments, the chelating agent used within the liquid leaching medium can be selected and/or configured for use in a basic liquid leaching medium (e.g., a liquid leaching medium having a pH of at least 8, such as from about 10 to about 14). Examples of such chelating agents include, but are not limited to, ethylenediaminetetraacetic acid (EDTA), nitrilotriacetic acid (NTA), hydroxyethylenediaminetriacetic acid (HEDTA), diethylenetri aminepentaacetic acid (DTPA), ethyleneglycol-bis(2-aminoethylether)tetraacetic acid EGTA, etc, and their salts. One of ordinary skill in the art would be capable of selecting a chelating agent suitable for use in a basic liquid leaching medium using no more than routine experimentation, for example, by performing the screening test outlined above for identification of suitable chelating agents, using a basic liquid leaching medium.

While the use of complexing agents and basic liquid leaching media have been described, certain aspects of the invention are not limited in this way, and acids (e.g., nitric acid, phosphoric acid, hydrochloric acid, and the like) and/or other lead-removal agents can be employed in the liquid leaching media. For example, in certain embodiments, agents (such as strong acids) that dissolve lead oxide to form lead can be used in the liquid leaching medium. In addition, liquid leaching media with basic or acidic pHs can be employed, in certain embodiments, although the use of acidic liquid leaching media can limit the extent to which lead is removed from the bulk of the lead-containing glass.

In certain embodiments, cavitation can be created within the liquid leaching medium during at least a portion of the time during which the lead-containing glass is exposed to the liquid leaching medium. For example, in certain embodiments, lead-containing glass and a liquid leaching medium can be disposed within a vessel, and cavitation of the liquid leaching medium can be achieved within the vessel. Cavitation can be created in the liquid leaching medium, for example, using a variety of mechanisms which can involve transferring energy to the liquid leaching medium. For example, in certain embodiments, cavitation can be achieved by applying acoustic energy to the liquid leaching medium. The acoustic energy can comprise ultrasonic waves, for example, at frequencies of at least about 20 kHz (e.g., between about 20 kHz and about 40 kHz). Ultrasonic waves can be applied to a liquid leaching medium, for example, by directing an ultrasonic horn at the liquid leaching medium, disposing the liquid leaching medium in an ultrasonic bath, immersing ultrasonic transducers within the liquid leaching medium, employing a flow-through ultrasonic reactor, or combinations of these methods.

In some embodiments, cavitation can be achieved by exposing the liquid leaching medium to electromagnetic radiation. For example, the liquid leaching medium can be exposed to a laser (e.g., comprising visible light), which can create optic cavitation. In certain embodiments, cavitation can be produced by exposing the liquid leaching medium to an electrical discharge (e.g., a spark). Cavitation in the liquid leaching medium can also be achieved by hydraulic cavitation, in which the pressure of a liquid in or near the liquid leaching medium falls below its vapor pressure. Cavitation can also be created by vibrating any surface disposed within the liquid, or by passing the liquid leaching medium through one or more obstacles to exert shear forces on the liquid. One of ordinary skill in the art, given the present disclosure, would be capable of determining other ways in which cavitation can be created within the liquid leaching medium.

Without wishing to be bound by any particular theory, it is believed that cavitation of the liquid leaching medium can produce shear forces that interact with the lead-containing glass to produce openings within the glass that provide additional pathways through which the lead-complexing agent can be transported into and out of the glass. Accordingly, cavitation of the liquid leaching medium can substantially enhance the degree to which lead is removed from the bulk of the lead-containing glass.

In certain embodiments, cavitation of the liquid leaching medium takes place under negative pressure and/or in an atmosphere containing an inert gas.

As noted elsewhere, the systems and methods described herein can allow for the removal of lead from the bulk of lead-containing glass, as opposed to just the surface of the lead-containing glass and regions near the surface of lead-containing glass. In certain embodiments, the liquid leaching medium removes at least a portion (e.g., at least about 2%, at least about 5%, at least about 10%, at least about 25%, at least about 50%, at least about 75%, at least about 90%, at least about 99%, or substantially all) of the lead that is at least 1 micrometer deep, at least 2 micrometers deep, at least 5 micrometers deep, at least 10 micrometers, at least 25 micrometers deep, at least 50 micrometers deep, or at least 100 micrometers deep relative to the exterior surface of the glass. Any of a variety of techniques capable of measuring or calculating the depth of removal of lead from a glass particle or object may be used to determine whether a lead removal method is successful in removing lead from a particular depth within a treated glass object or particle. For example, a mass balance method may be used to calculate and infer the depth of removal. In one exemplary method, a glass object, particle or plurality of objects/particles having a known size/mass/volume and shape (or known distribution of sizes and shapes in the case of a plurality of objects/particles) and a known concentration of lead within the object(s)/particle(s) is exposed to a known volume of leaching solution under the desired test conditions. After the leaching is completed, the concentration of lead is measured in the leaching solution by known methods. From this concentration, the total quantity of lead leached from the glass is determined, and from this quantity and the size and shape data characterizing the object(s)/particle(s), a depth of removal can be determined with the conservative assumption that the lead leaches from the glass in a manner such that all of the lead at a given depth must leach from the glass before any lead leaches from greater depths. Alternatively, the depth of the lead-depleted zone in a glass particles/objects subjected to leaching may also be determined, in certain embodiments, by analyzing the particles/objects through the use of RBS (Rutherford backscattering spectrometry) and/or XPS (X-ray photoelectron spectroscopy) (see, e.g. Bertoncello, R. et al. (2004) Leaching of lead silicate glasses in acid environment: compositional and structural changes. Appl. Phys. A 79, 193-198, which is incorporated herein by reference).

In some embodiments, the systems and methods described herein can be used to remove a realtively large amount of the total lead that is originally present in the untreated lead-containing glass. For example, in certain embodiments, at least about 2%, at least about 5%, at least about 10%, at least about 25%, at least about 50%, at least about 75%, at least about 90%, at least about 99%, or substantially all of the lead that is originally contained within the lead-containing glass is removed from the lead-containing glass during exposure to the liquid leaching medium. One of ordinary skill in the art would be capable of determining the amount of lead removed during a leaching liquid treatment step by using EPA Method 3052 to determine the amount of lead in an untreated sample and a treated sample, and comparing the relative amounts. In certain embodiments, after treatment, the treated glass contains lead in an amount of less than about 50 wt %, less than about 25 wt %, less than about 10 wt %, less than about 1 wt %, or less than about 0.1 wt %.

In certain embodiments, the liquid leaching medium and leaching systems/unit operations of the invention can be configured to achieve effective bulk leaching of lead from lead-containing glass. The performance of such liquid leaching media/systems can be analyzed according to, for example, the following screening test. A substantially spherical lead-containing glass particle can be exposed to the liquid leaching medium, and the liquid-leaching medium can be allowed to extract lead from the lead-containing glass until the concentration of lead within the liquid leaching medium has stabilized. The efficacy of the lead removal from the particle can then be analyzed by subjecting the particle to EPA Method 3052, which can be used to determine the amount of residual lead left in the treated glass particle. In certain embodiments, the systems and methods described herein are able to treat a substantially spherical lead-containing glass particle having a cross-sectional diameter of at least about 2 micrometers or at least about 10 micrometers by exposing it to a liquid leaching medium such that substantially all of the lead is removed from the glass particle.

In certain embodiments, lead can be leached from the bulk of the lead-containing glass (e.g., to any of the degrees mentioned herein, including substantially complete leaching of the lead from the bulk of the lead-containing glass) at a relatively fast rate. In certain embodiments, substantially all of the lead can be removed from the lead-containing glass within 24 hours or within 6 hours of first exposure of the lead-containing glass to the liquid leaching medium. It is believed that substantially complete removal of the lead from the lead-containing glass can be achieved at even faster rates (e.g., within 1 hour, within 30 minutes, or within 5 minutes) in embodiments in which industrial-grade mixing systems (which are capable of achieving enhanced rates of transport of lead away from the glass particles, relative to the rates that can be achieved using lab-scale equipment) are employed.

The step of exposing the lead-containing glass to the liquid leaching medium can be performed at any suitable temperature. In certain embodiments, the exposure step is performed at relatively low temperatures (e.g., between about 20° C. and about 100° C., or between 80° C. and about 90° C.) in order to reduce the amount of energy consumed by the recycling process. In some embodiments, the lead extraction step can be performed at room temperature (i.e., about 25° C.).

In certain embodiments, at least a portion of the treated glass can be separated from at least a portion of the liquid leaching medium. The treated glass and the liquid leaching medium can be separated using any suitable separation technique. For example, in certain embodiments, a mixture of the treated glass and the liquid leaching medium can be filtered such that the treated glass is retained by the filter and the liquid leaching medium is transported through the filter. Optionally, negative pressure can be applied to the filtrate side of the filter (e.g., using a vacuum) to enhance the rate of transport of the liquid leaching medium through the filter. Of course, other separation techniques, such as evaporation, could also be used to separate the treated glass from the liquid leaching medium.

Certain aspects of the present invention relate to integrated systems for recycling leaded glass. As used herein, an “integrated system” is one in which each of the unit operations within the system communicates with at least one other unit operation in the system, including a central control system, as opposed to systems in which unit operations perform functions completely independently from each other. In certain embodiments, the integrated system can be housed within a single building or a collection of buildings on a single campus. In some embodiments, each unit operation within the integrated system sends data to and/or receives data from a control system.

In certain embodiments, the systems described herein comprise at least one unit operation that is automated. As used herein, a unit operation is “automated” when it is operated without substantial manual human intervention during operation. In certain embodiments, each of the unit operations within the systems described herein can be automated. For example, in some embodiments, integrated systems are described in which each unit operation within the integrated system is automated. This can be achieved, for example, by employing a central control system that directs the operation of the recycling system.

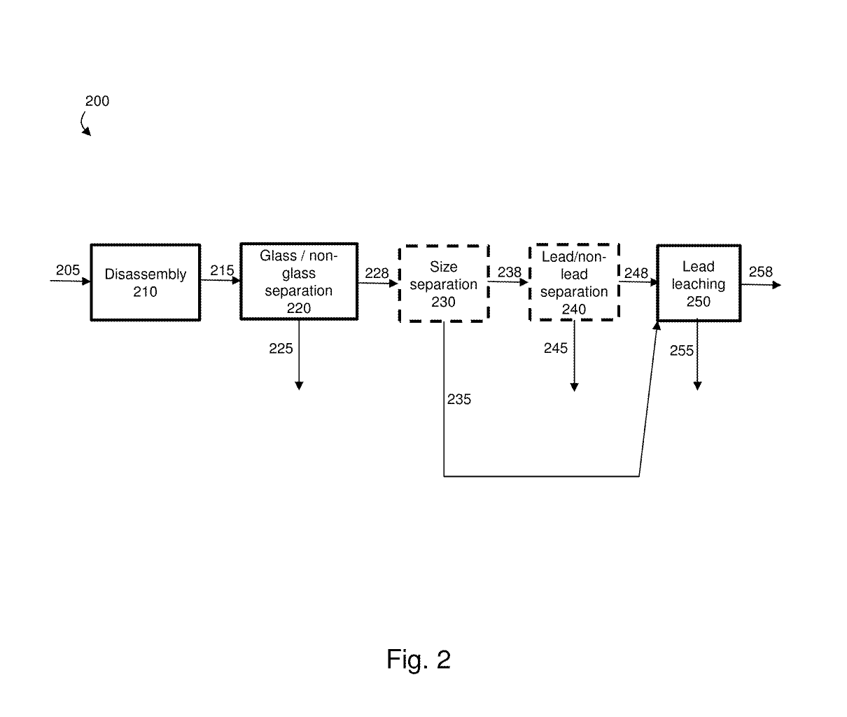

One example of an integrated system 200 configured for recycling electronic equipment comprising leaded glass is illustrated in FIG. 2. In certain embodiments, integrated system can comprise a first stage 210 in which a substantially intact piece of electronic equipment comprising glass components and non-glass components (entering via pathway 205) is disaggregated (e.g., disassembled, crushed, or otherwise broken apart) to produce glass components and non-glass components (which can exit via stream 215). Any suitable type of electronic equipment can be used as the feedstock. In certain embodiments, the electronic equipment comprises a cathode ray tube (CRT). Exemplary types of such electronic equipment include, but not limited to, computer monitors, televisions, oscilloscopes, and the like.

A typical composition of a color monitor, which is one example of a piece of electronic equipment that can be used in association with certain aspects of the present invention, is shown in Table 1. Glass, steel, iron, copper yoke, printed circuit board and plastics are its main components. In certain embodiments, each of these components can be separated and collected for further recycling. According to certain aspects of the invention, a whole computer monitor, a television set, and/or a bare CRT may be accepted as an input material.

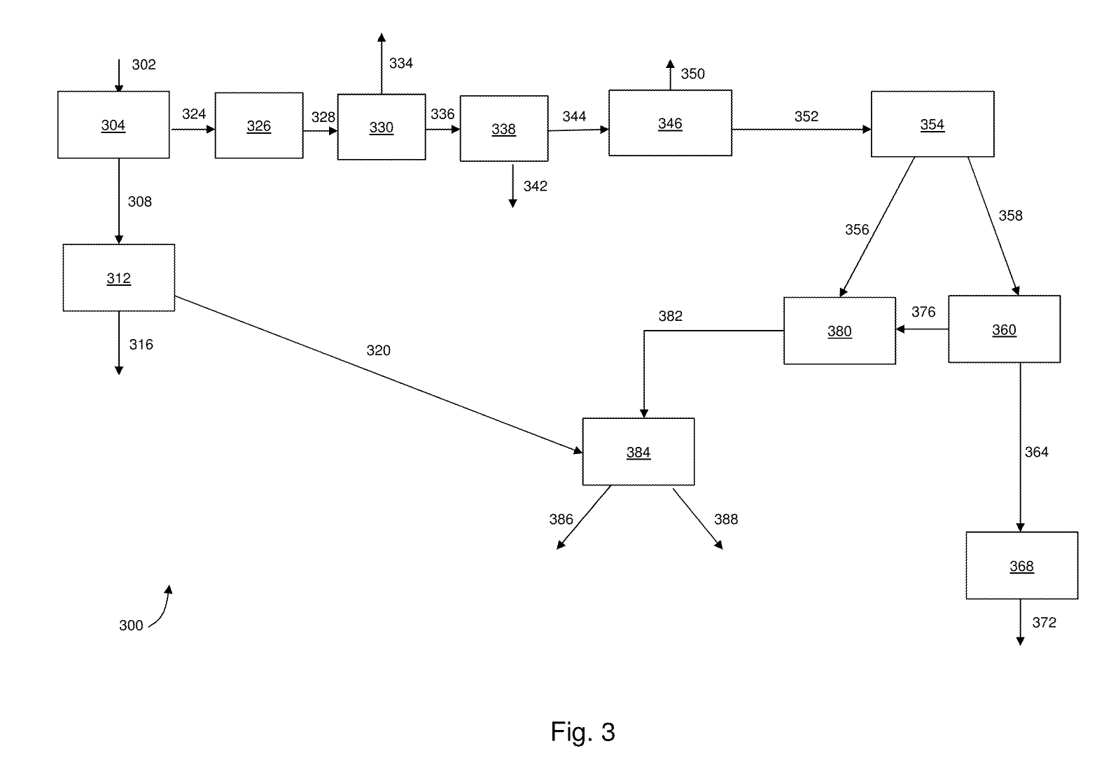

Disaggregation of the intact piece of electronic equipment can be achieved using any suitable device. In certain embodiments, a shredder can be used to disaggregate the electronic equipment. For example, FIG. 3 includes a flowchart of an exemplary system 300 for disaggregating and recycling the components of electronic equipment (within stream 302) using a primary shredder 304, which is shown as the first element of the flowchart in FIG. 3. The distance between the shafts of the shredder can be set such that after passing through it, the main fractions of the recycled materials are liberated, although the size reduction is not critical at this stage of the separation process.

In certain embodiments, the glass components of the electronic equipment (which are generally much more brittle than the other materials) can break into small pieces relatively easily, and can therefore be automatically separated from the other larger components (e.g., yokes, shadow masks, and the like), which might not undergo size reduction.

In some embodiments, glass dust can be formed during disaggregation of the electronic equipment. For example, when a primary shredder is used, a large amount of glass dust is usually formed. Accordingly, in certain embodiments, it is preferred to operate the disaggregation equipment in a sealed environment.

TABLE 1
Analysis of components in a 14 in. Philips colour monitor

| Item | Material | Weight (kg) | Wt. % |
|---|---|---|---|
| Shell | Plastic | 2.032 | 17.38 |
| CRT explosion-protection | Iron | 0.213 | 1.82 |
| unit | | | |
| CRT unit | | 5.638 | 48.23 |
| Shadow mask | Steel | 0.455 | 3.89 |
| Panel glass | Glass | 3.356 | 28.71 |
| Funnel glass | Glass | 1.731 | 14.81 |
| Gun | Steel, glass, copper, | 0.096 | 0.82 |
| | plastic | | |
| Yoke | Copper, plastic, | 0.589 | 5.04 |
| | iron | | |
| Metal parts | Iron | 0.542 | 4.64 |
| IC board | IC, resin, copper, | 1.676 | 14.34 |
| | iron | | |
| Wire | Copper, plastic | 0.66 | 5.65 |
| Rubber parts | Rubber | 0.048 | 0.41 |
| Plastic parts | Plastic | 0.291 | 2.49 |
| Total | | 11.690 | 100.00 |

Referring back to FIG. 2, integrated system 200 can also comprise a second stage 220 in which at least a portion of the glass components entering via stream 215 are separated from at least a portion of the non-glass components. When electronic equipment comprising lead-containing glass is used, at least a portion of the glass components separated from the non-glass components comprise lead-containing glass. After the components have been separated, the non-glass components can exit the glass separation stage via stream 225. Various non-glass components can be separated for subsequent recycling, as described in more detail below. Glass components can exit separation stage 220 via stream 228.

For example, in the system illustrated in FIG. 3, glass fines (i.e., generally glass particles having cross-sectional diameters of less than 10 mm) within stream 308 can be separated from non-glass components and additional glass (within stream 324) as they are passed through a vibratory double deck. The glass fines can contain some metallic impurities. Accordingly, in certain embodiments, the glass fines fraction within stream 308 can be transported through a separator 312 (e.g., a magnetic separator), where ferrous metals can be removed via stream 316. In some embodiments, the glass fines within stream 320 can be then sent directly to an optional size reduction unit (not illustrated in FIG. 3), followed by the leaching operation to extract lead in unit 384 (e.g., a vessel), discussed in more detail elsewhere.

After passing through the primary shredder, the crushed waste stream 324 that has been separated from the glass fines can be collected on a vibratory feeder 326. A dedusting system can be installed over the vibratory feeder, in certain embodiments, which can be used to capture phosphorous powder, fine glass dust, and other fine powders and dusts, which may be liberated by the shredding step. The material stream that is separated from the glass fines can then be forwarded via stream 328 to a magnetic separator 330, which can be used to remove ferrous components such as steel scrap via stream 334. Subsequently, crushed waste stream 336 can be transported to an eddy current separator 338, in which copper-containing yokes and wires can be separated from the main material flow via stream 342. Crushed waste stream 344 can then be fed to an air density separator 346, which enables separation of printed circuit boards, plastics, rubber and wooden parts of old TVs via stream 350. All of the separated material streams (e.g., steel scrap, copper-containing components, plastics, rubber, wood, etc.) can then be collected and sent to appropriate recycling facilities.

Referring back to FIG. 2, in certain embodiments, it can be beneficial to separate the glass components within stream 228 that do not contain lead from the lead-containing glass within stream 228 prior to subjecting the glass-containing stream to the leaching step. By separating out glass that does not contain lead from the glass stream, the efficiency of the lead leaching step can be enhanced, in certain embodiments. Accordingly, system 200 in FIG. 2 includes optional separation unit 240, which can be used to separate at least a portion of the lead-containing glass from at least a portion of the glass that does not contain lead. Separation unit 240 can comprise, for example, an optical sorter, a laser sorter, or an x-ray sorter. Suitable equipment for use in separation unit 240 is described in more detail below.

In certain embodiments (including some embodiments in which separation unit 240 comprises an optical sorter), separator 240 cannot be used to sort glass particles under a predetermined size (e.g., 10 mm). Accordingly, in certain embodiments in which separator 240 is used to separate lead-containing glass from glass that does not contain lead, size separation unit 230 can be used to separate the glass into two fractions: a first fraction smaller than the threshold size that can be sorting by separator 240 and a second fraction that is larger than the threshold size that can be sorted by separator 240. The first fraction can be transported out of separator 230 via bypass stream 235, which can be transported to lead leaching apparatus 250. The second fraction can be transported out of separator 230 via stream 238 to separation unit 240.

A variety of suitable size-based separators, including screens and other suitable size-based sorters, can be used as separator 230, as described in more detail below.

Separation unit 240 can be used to separate the glass within stream 238 into a first fraction containing lead and a second fraction that does not contain lead. The non-leaded glass can be transported out of the system via stream 245, after which it can be recycled. The leaded glass can be transported out of separator 240 via stream 248 to lead leaching unit 250, described in detail elsewhere.

FIG. 3 includes an exemplary illustration of how such a glass sorting procedure can be carried out. After all the separations described above have been completed, the main material flow emanating from the air density separator in stream 352 contains substantially only crushed, mixed glass comprising lead and non-lead glass components, sometimes with some impurities. This stream can be transported to to a size-based separator 354 such as a finger screen, which can be used to create two streams of glass particles—one stream 356 containing particles less than 10 mm large and a second stream 358 containing particles larger than 10 mm. In FIG. 3, the larger particles are suitable for the downstream glass sorting procedure and are accordingly transported to a glass sorting unit 360, where glass is sorted according to the lead content. Lead-containing glass can be transported to the lead extraction unit 384 (optionally after being reduced in size in size reduction unit 380, described in more detail below), and non-leaded glass can be transported out of the system via stream 364. Optionally, the non-leaded class can be reduced in size in size reduction unit 368 (e.g., an impactor) to form milled, non-leaded glass in stream 372. All the rejected particles, which are smaller than 10 mm, are generally unsuitable for sorting according to the glass composition because of the technical limitations of glass sorters, and can be forwarded to the leaching operation 384 (optionally after being passed through a size reduction unit 380 such as an impactor) via stream 382.

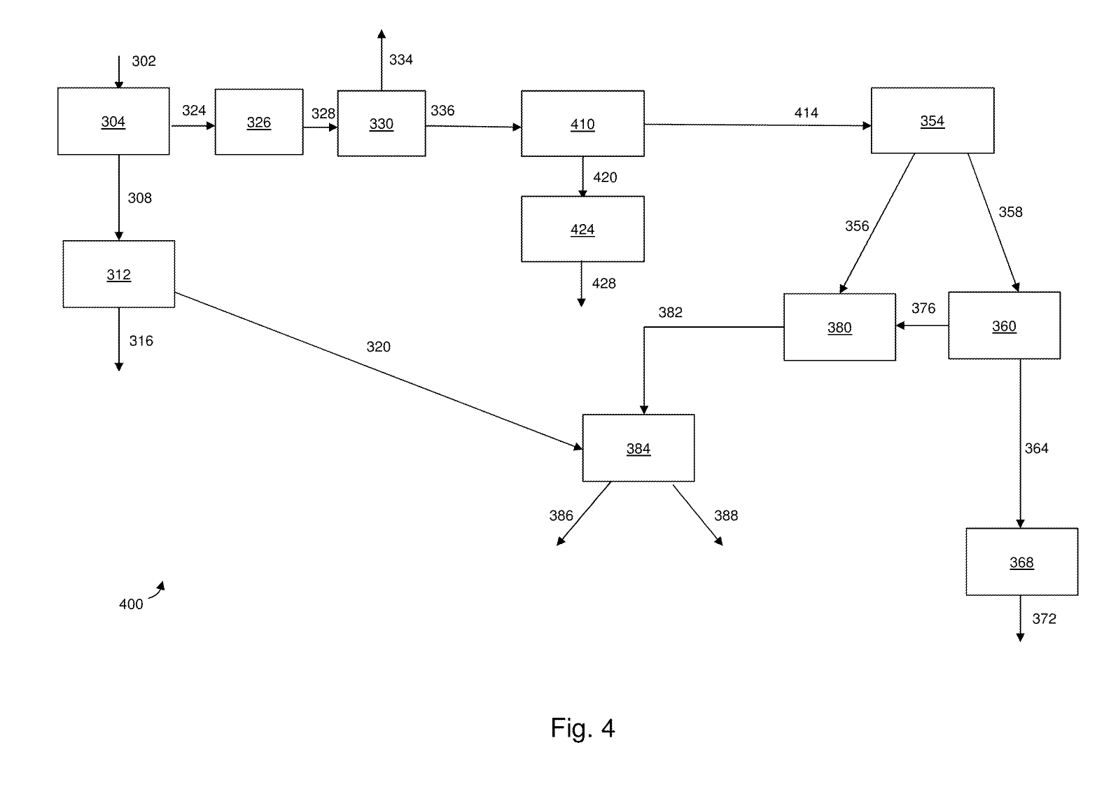

FIG. 4 includes a schematic illustration of an alternative process 400 in which an optical sorting device 410 is used to separate the disaggregated waste instead of the eddy current separator 338 and air density separator 346 illustrated in FIG. 3. In this set of embodiments, after primary crushing, separation of glass fines and magnetic separation, the material within stream 336 can be forwarded to optical sorter 410, which can be programmed for separation of glass (which can be transported via stream 414) from the rest of the materials (which can be transported via stream 420). This type of separation for crushed CRT glass has been proven to work with high accuracy and efficiency. Exemplary optical sorters that can be used for this purpose include the Spyder Digital laser sorter manufactured by Visys NV (Belgium). This type of sorter combines color, structure, shape and size sorting and is particularly suitable to separate crushed CRT material.

In FIG. 4, after the material is passed through the optical sorter, the main material flow can be separated into two fractions: a mixed glass fraction (containing lead and non-lead glass, which can be transported via stream 414) and a non-glass fraction, which will mainly include pieces of printed circuit boards, metal, plastics, copper yokes, some rubber and also wood (e.g., from old TVs), and the like, which can be transported via stream 420. The non-glass fraction in stream 420 can be further separated into useful output material fractions (in stream 428) using a separator 424, which can be the same optical separation system as used in separator 410, a conventional eddy current separator, air density separator, magnetic separator, and the like. The mixed glass fraction in stream 414 can be forwarded to a separator 354 (e.g., a finger screen) where the glass particles can be divided into smaller than 10 mm and larger than 10 mm fractions (for the separation of glass fines from the rest of the glass), as described elsewhere.

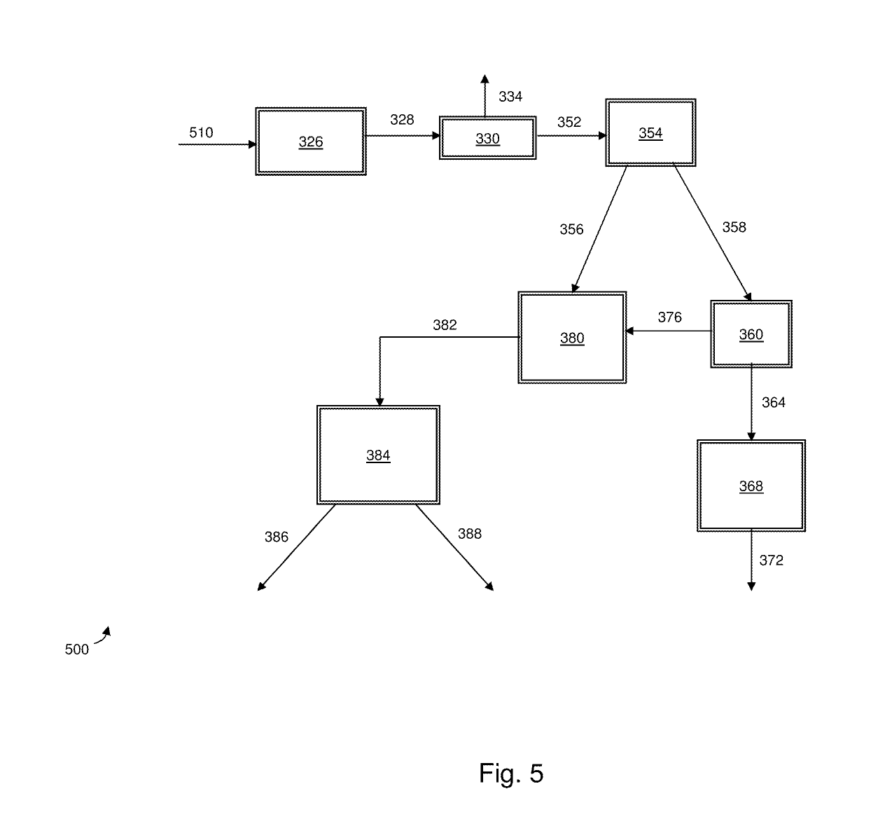

In certain embodiments, the waste input material comprises only bare CRTs, which can be pre-separated, for example, from televisions, CRTs, and the like in previous operations. In some embodiments, the waste input material comprises simply mixed lead and non-lead glass. An exemplary schematic flow diagram illustrating system 500 for the treatment of bare CRTs and mixed glass input materials 510 is presented in FIG. 5. Generally, the main components of a bare CRT are lead and non-lead glass, an electron gun (mainly comprising glass and stainless steel), a shadow mask, and a steel belt wrapping the tube along the frit line (line connecting panel and funnel glass). The bare tubes can be crushed (e.g., in a shredder or any other type of size reducing equipment such as an impact crusher, jaw mill, cone mill, etc.). Subsequently, the metallic parts can be removed using a magnetic separator 330, leaving a crushed mixed glass fraction 352 substantially free of impurities. A vibrating double deck or a finger screen 354 can be used to separate mixed glass particles sized less than 10 mm to be forwarded directly to the size reduction and then to the chemical leaching process. The rest of the components illustrated in FIG. 5 can be similar to those described in association with FIGS. 3 and 4, and are numbered accordingly.

Referring back to the set of embodiments illustrated in FIG. 2, any type of process or device capable of separating lead glass from non-lead glass can be used as separator 240, including optical sorters, as described elsewhere. As noted above, the advantage of separating the two types of glass (i.e., leaded and non-leaded) is mainly that the separation reduces the volume of glass that is subject to the lead extraction process, thereby increasing the efficiency of the process. According to data specified in Table 1, the weight of non-lead panel glass within a typical monitor is almost two times larger than the weight of lead-containing funnel glass. Accordingly, separation of crushed panel glass from crushed funnel glass can provide one the opportunity to reduce the quantity of chemically treated glass by the factor of 3. Another considerable advantage is that the automatic glass-sorting system can serve to replace the operation of very high labour consuming manual separation of two types of glass, which is normally employed by the majority of recyclers. As it was shown by Cui, et al., the recycling of TV scrap was not expected to be economically viable using conventional manual dismantling. (Cui, J. and Forssberg, E., “Characterization of shredded television scrap and implications for material recovery,” Waste Management, 27, 415-424, 2007.) Thus, the combination of mechanical crushing of waste tubes followed by the separation of two types of glass provides the advantages of high automation in crushing of CRT glass, in the separation of the glass components from non-glass components (e.g., if whole monitors and TVs are present in the input) and in segregation of lead-containing glass from non-leaded glass, contrary to the low-efficiency processes of manual dismantling and manual separation of two types of glass applying hot wire method, laser cutting method, etc.

Lead glass generally has a higher density then non-lead glass. Accordingly, a sink-float separation in heavy liquids can be applied for the separation of these two types of glasses. One disadvantage of this method is that it generally cannot provide with high accuracy of separation, given that glass can be broken in such a way that some glass chunks may comprise two fractions—leaded and non-lead glass, which can be connected, for example, by a frit line. Such particles can have an intermediate density which is less than the density of lead glass and more than the density of non-lead glass. Because of the presence of such particles, the accuracy of sink-float separation can be significantly decreased, in certain embodiments. Also, the amount of lead content used in the manufacturing of both panel and funnel glass has varied over the years. CRT glass manufactured in earlier days sometimes included panel glass with a lead content of up to 3.25%, while funnel glass had a lead content in the 14-15% range. Therefore the density of lead glass originating from old and from new CRTs varies greatly, which can make density based separations difficult to perform.

Accordingly, in certain embodiments, optical laser sorting (e.g. using a Spyder Digital Laser Sorter manufactured by Visys NV, Belgium) and/or XRF-sorting (e.g., using a Varisort XE-G separator manufactured by S+S Separation and Sorting Technology GmbH, Germany and TITECH X-tract separator manufactured by TITECH) can be preferred for sorting of leaded glass (e.g., funnel glass) from non-leaded (e.g., panel) glass.

The Spyder sorter is generally capable of sorting glass particles 10 mm and larger. The TITECH X-tract separator can efficiently separate glass particles in the size range between 8 mm and 100 mm. Optical and X-ray sorting systems, applied to sorting two types of CRT glass, can provide very high separation quality which can assure that the non-lead fraction will not be polluted with lead-containing particles. For example, the purity of the panel glass particles separated using the TITECH separator can generally be above 99.9% (i.e. less than 0.1% lead glass content in non-lead glass fraction), and the recovery of panel glass can generally be above 90%. Therefore, in such embodiments, the separated panel glass does not contain substantial amounts of dangerous admixtures and can be directly used in different applications requiring non-lead glass, as in cement making, road construction, sandblasting, as waste glass that is to be melted, etc. In certain embodiments in which the treated glass particles are not regular in size and shape, size reduction of separated non-leaded panel glass can be performed (e.g., in a ball mill or any other size reducing unit) with the purpose of producing glass in more compact form, which may be practical before shipping out the glass.

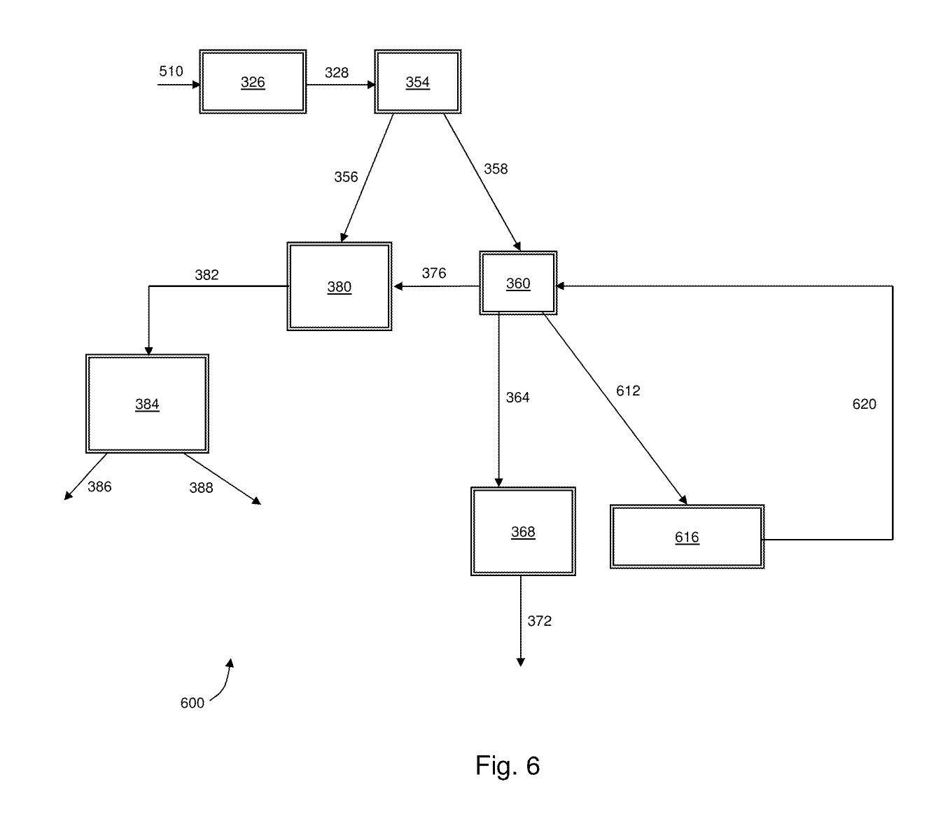

The sorting system can also be programmed for separation of frit glass (glass particles consisting of both panel and funnel glass, connected by the frit line) in a separate material fraction, as is shown in exemplary process 600 outlined in FIG. 6. The process in FIG. 6 is similar to the process outlined in FIG. 5, except that a fraction containing mixed glass attached by a frit line can be separated using glass sorter 360 to form a separate stream 612. Stream 612 can be sent directly to a chemical leaching stage 616, where glass particles consisting of mixed glass can be subjected to the action of a leaching solution, optionally without any preliminary size reduction. Generally, the frit line contains relatively large amounts of lead oxide (e.g., generally around 70-75 wt %, see Table 3). It has been found, in the framework of the present invention, that it was possible to substantially completely dissolve the lead oxide of the frit line in the leaching solution within leaching stage 616, such that the frit line is substantially completely destroyed and the panel and the funnel glass portions were physically separated without application of any additional mechanical force. The so obtained mixture of panel and funnel glass can be then separated from the leaching medium, optionally rinsed with water and dried and returned to the glass sorting system via stream 620, where it is further separated in lead and non-lead fractions.

A similar process can also be used for non-destructive separation of funnel and panel glass of the whole cathode ray tubes, if needed. Instead of using commonly applied procedures that can be highly labor intensive (such as hot wire cutting, laser cutting, water jet cutting, etc.), the whole CRT can be immersed into the leaching solution in such a manner, that the frit line remains in contact with the leaching solution. As soon as frit line dissolves, the CRT can be separated into funnel and panel parts.

TABLE 2
Lead oxide content in typical CRT glass components

| Glass | Color CRT, % | Monochrome CRT, % |
|---|---|---|
| Panel | 0-3 | 0-3 |
| Funnel | 24 | 4 |
| Neck | 30 | 30 |
| Frit | 70 | n/a |

* Data from Townsend, T. G. et al. (1999) Characterization of lead leachability from cathode ray tubes using the toxity characteristic leaching procedure. Report #99-5, State University System of Florida, Florida Center for Solid and Hazardous Waste Management.

TABLE 3
Five major ingredients of typical frit glass

| | Zinc | | | |
|---|---|---|---|---|
| Lead Oxide | Oxide | Boric Oxide | Barium Oxide | Silicon Dioxide |
| 75% | 12% | 9% | 2% | 2% |

* Data from “Frit Facts. A brief Technological Summary of Television Solder Glass,” from Techneglas.

In certain embodiments, including those illustrated in FIGS. 3-6, the separated lead glass fraction (which can contain sorted lead (funnel) glass and also glass fines (unsorted glass particles smaller than 10 mm)) can then be forwarded to an optional size reduction unit 380 (e.g., a horizontal impactor, a ball mill, a vibratory mill or any other suitable size reduction unit), which can be used to economically reduce the size of glass particles to micrometer size ranges. In certain embodiments, wet size reduction may be preferred for dust suppression. In some embodiments, it can be preferable to obtain as narrow particle size distribution as possible, for example, for the purpose of achieving homogeneous lead removal. The preferable size range of milled lead glass particles can vary depending on the requirements of the end-product. Generally, the smaller the particles, the more lead can be extracted over a set period of time. In certain embodiments, the size of glass particles may be additionally reduced by application of ultrasound during the leaching stage. In other embodiments, application of ultrasound during the leaching stage does not substantially reduce the size of the glass particles.

Referring back to the set of embodiments illustrated in FIG. 2, integrated system 200 can further comprise a stage 250 which can comprise a liquid leaching medium able to extract at least a portion of the lead from the lead-containing glass. Stage 250 can comprise any of the liquid leaching media described elsewhere herein. The lead that is extracted from the lead-containing glass can be transported out of lead leaching unit 250 via stream 255. The treated glass, which can be substantially free of lead in certain embodiments, can be transported out of lead leaching unit 250 via stream 258.

In the set of embodiments illustrated in FIG. 3, lead glass particles (which are optionally reduced in size) are brought into contact with a leaching medium at stage 384, with the purpose of removing lead (and thus, lead oxide) from the glass, from the lead glass composition. Stage 384 can include, for example, a vessel containing a liquid leaching medium, a platform over which a liquid leaching medium is cascaded over the lead-containing glass, or any other suitable device suitable for establishing contact between the lead containing glass and the liquid leaching medium. The lead leaching step can be used to produce a lead-containing liquid stream 386 (e.g., containing lead in the form of lead salts, lead hydroxide, or metallic lead) and a treated class containing stream 368 (which can include, for example silica particles such as silica flour).

While the use of chelating agents and other complexing agents has been described above, it should be understood that the integrated processes described herein are not limited to the use of such agents. For example, in certain embodiments, acids can be used to remove lead from lead-containing glass. In some embodiments, the liquid leaching solution comprises acetic acid, a carboxylic acid, nitric acid, methanesulfonic acid, mixtures thereof, and/or salts thereof. In some such embodiments, lead oxide will be eliminated from the glass matrix on and near the surface layers of the glass particles (usually down to depths of around 500 nanometers). After such removal, the surface can become safe and lead-free and the remaining lead can be encapsulated in the inner glass layers and cannot be dissolved, leached, or removed in further applications of the treated glass. This can make the glass safe and able to pass the Toxicity Characteristic Leaching Procedure (TCLP) test.

In cases in which acids are used in the leaching medium, if complete or almost complete elimination of lead from the lead glass is required (e.g., 1-2 wt % of remaining lead oxide in the treated glass), such levels can be achieved by reducing the particle size of the lead-containing glass to such a range as allows the extraction of the required quantity of lead oxide (e.g., leaving only 1-2 wt % of lead oxide encapsulated in the glass matrix in the interior of the glass particles). As was shown in Bertoncello, R. et al. “Leaching of lead silicate glasses in acid environment: compositional and structural changes.” Appl. Phys. A 79, 193-198, (2004), for leaching of lead silicate glasses (45.3 wt % of lead oxide) in aqueous solutions of nitric acid, a leached layer, depleted of lead and alkaline ions is formed on the surface of the lead glass particles, after they are subjected to leaching. The thickness of this layer increases with the leaching time and reaches a maximum of about 500-580 nm in a stabilized state (when surface lead leaching stops). This surface layer can contain almost pure SiO₂. The silica layer can protect glass from further leaching so that the stabilization of leaching is achieved. As has been confirmed experimentally for lead silicate, alkaline, and alkaline-earth silica glasses, the following ionic exchange reaction usually takes place in acidic leaching environments:

≡Si—O—Pb—O—Si≡+2H⁺=>2≡Si—OH+Pb²⁺ (1)

In some cases when the lead glass contains more lead (e.g., like frit line glass), it can be leached more easily and the thickness of the area from which lead is leached can reach several micrometers, although complete removal of the lead within this thickness would not generally be achieved.

Based on the confirmed thickness of the stabilized leached layer of 500 nm for lead silicate glass, it is expected that almost all lead can be removed from lead glass by acid leaching, if the initial size of lead glass particle is around 1 micrometer or smaller.

While any leaching medium capable of dissolving lead oxide can be applied as a leaching media for lead glass, with both acidic and basic leaching media being effective, the use of acids (e.g., nitric acid, hydrochloric acid, hydrofluoric acid, and the like) can pose disadvantageous in certain cases, and certain aspects of the invention relate to mitigating these disadvantages. For example, acids forming insoluble lead salts (e.g., sulfuric acid, hydrochloric acid, phosphoric acid, etc.) can cause problems, and in certain embodiments, the leaching medium is substantially free of such acids, which can simplify the leaching process. If an insoluble lead precipitate is formed in the leaching process, it will often be substantially immediately mixed with the treated glass. In some such cases, a follow-up leaching process can be used (and can be required, in certain instances) to dissolve the formed lead precipitate, so that the treated glass can be separated from the salts of leached lead. Accordingly, to reduce complication, in certain embodiments in which the leaching medium contains an acid, the acid is capable of attacking lead oxide and forming a water soluble salt of lead. Examples of such acids include, but are not limited to, acetic acid, nitric acid, sulfamic acid, citric acid and all carboxylic acids, etc. Alternatively, in certain embodiments, the liquid leaching medium can contain an acid capable of attacking lead oxide to form an insoluble salt of lead, and another acid in which the said insoluble salt can be dissolved. In certain embodiments, the leaching media can contain a chemical composition capable of binding dissolved lead. For example, the liquid leaching medium can contain a mixture of nitric acid and methanesulfonic acid, in which nitric acid interacts with lead oxide, bringing the Pb²⁺ ions into the solution, and methanesulfonic acid accumulates these ions, being capable to keep up to 1033 g of lead salt per litre of the solution at 22° C. In certain embodiments, the chemical composition capable of binding the dissolved metal comprises any sort of complexing agents, chelating agents, or other similar chemical compounds known in the art, capable to physically or chemically bond metallic ions and that are compatible with the other components (e.g., acids) in the liquid leaching medium.

As mentioned elsewhere, it has been shown, within the framework of one aspect of the present invention, that a solution comprising a chelating agent (e.g., in which the chelating agent is the majority or sole lead-complexing agent within the liquid leaching medium) can be highly effective for lead removal from lead-containing glass (including milled lead glass). In order to make the leaching medium more effective, it can be advantageous to increase the solubility of a chelating agent. This can be achieved in many cases (including cases in which the chelating agent EDTA (e.g., disodium EDTA) is used) by raising pH of the medium. For example, a pH=8-9 corresponds to a range of higher stability of lead-EDTA complexes.

As noted above, in certain embodiments, EDTA can be used as a chelating agent in the liquid leaching medium, in certain embodiments. EDTA is a chelating agent that binds 2-valent metals in equimolar proportion according to the following:

2Na⁺+2H⁺+EDTA⁴⁻+Pb²⁺=>(Pb−EDTA)²⁻+2Na⁺+2H⁺ (2)

In addition, as noted above, it is believed that the glass matrix is chemically affected when the liquid leaching medium has an elevated pH. In addition, it is believed that this effect is more intense if fine glass powder is used (e.g. particle sizes less than about 100 microns). As a result, it can be easier for lead ions to leave the glass structure and to be transferred into the leaching medium when elevated pHs are employed.

In certain embodiments, enhanced lead extraction can be achieved when using chelating agents when the leaching process is performed in at least two stages: a first stage in which the chelating agent is added, and a second stage in which the concentration is diluted and/or cavitation is induced in the liquid leaching medium. In one particular set of embodiments, during the first stage, glass (e.g., glass powder) can be mixed with the chelating agent (e.g., EDTA) and a small amount of water, and the pH can be raised to increase the solubility of the chelating agent (e.g., EDTA). The components can be mixed together until a gelatinous paste is formed. Without wishing to be bound by any particular theory, it is believed that this paste is formed due to some sort of sol gel forming reactions. In certain embodiments, once the paste is formed, the second stage is commenced in which water is added to the paste, and the slurry is mixed and cavitated (e.g., via sonication).

In certain embodiments, vigorous mixing of the slurry of the milled glass particles and the liquid leaching medium can be employed, which can accelerate lead extraction. It has been discovered, that the leaching reaction can be accelerated (and, in some embodiments, dramatically accelerated) if the leaching medium is irradiated by ultrasound, compared to leaching processes in which mixing is not employed. Ultrasound can cause high-energy acoustic cavitation, accompanied by formation, growth and implosive collapse of bubbles in a liquid, and/or the creation of very high local temperatures and high pressures. These bubbles can collapse in the compression part of the wave, creating high-energy movements of the solvent, which can result in localized high shear forces. Shock waves from cavitation in liquid-solid slurries can also produce high velocity inter-particle collisions, in certain cases. In some embodiments, the application of ultrasound can cause additional size reduction or abrasion of glass particles, which can serve to increasing the surface area between reactants. However, it should be understood that the application of ultrasound does not always result in particle size reduction of the glass particles, and in other embodiments, substantially no reduction in particle size occurs when ultrasound is applied. In certain embodiments, as a result of application of ultrasonic irradiation or any other means to create cavitation in the liquid leaching medium (e.g. hydrodynamic cavitation, or any other of the cavitation formation mechanisms described herein), relatively high amounts of lead can be leached from the crushed lead glass over relatively short times.

In some cases, as soon as lead atoms leave the glass surface, the surface becomes porous and can easily absorb the leaching medium containing dissolved lead. In many cases, this absorbed solution cannot be effectively removed by simple rinsing. In fact, in many cases, after the glass loses lead as lead leaves the glass surface, a certain amount of lead is re-absorbed by the glass surface from the leaching medium, which contains dissolved lead. In a series of experiments in which lead glass was treated with leaching medium containing only chemicals capable of dissolving lead (e.g., acids), but no binding agents, it was observed that, while leaching of lead took place (i.e., lead was transferred to the leaching medium), certain treated lead glass samples were not able to pass TCLP because of the presence of the surface lead, which was re-absorbed by the glass. In certain embodiments, the re-absorption of lead can be mitigated by including a chelating agent and/or a cation-exchange material (e.g., a cation exchange resin) within the liquid leaching medium. For example, in the above-described experiment, when a chelating agent or a cation-exchange resin was introduced in the leaching medium, the leached lead was either kept in the solution in highly soluble form (e.g., when using chelating agents) or was absorbed by the ionic exchange resins. In such cases, the lead could be removed from the leaching medium, such that it was not re-absorbed on the glass surface, and the glass samples passed TCLP successfully.

The lead glass can be brought into contact with the liquid leaching medium for a period of time sufficient for surface lead to form a complex with or be dissolved by a component(s) in the leaching medium. This time period can depend upon the size of glass particles and the concentration of the leaching medium. The leaching can generally be considered to be complete when the concentration of leached lead in the leaching medium achieves a constant value.

After leaching (e.g., after the leaching endpoint has been detected), the glass can be separated from the leaching medium by any known liquid-solid separation technique, such as filtration, centrifugation, decantation and the like. The separated glass may be subsequently intensively washed with water so that the remaining leaching medium, which contains dissolved lead, is substantially completely removed. The rinse water can be re-used several times depending on its purity and can be recycled using any of a variety of known industrial rinse water purification techniques, such as reverse osmosis, ionic exchange, distillation, etc.

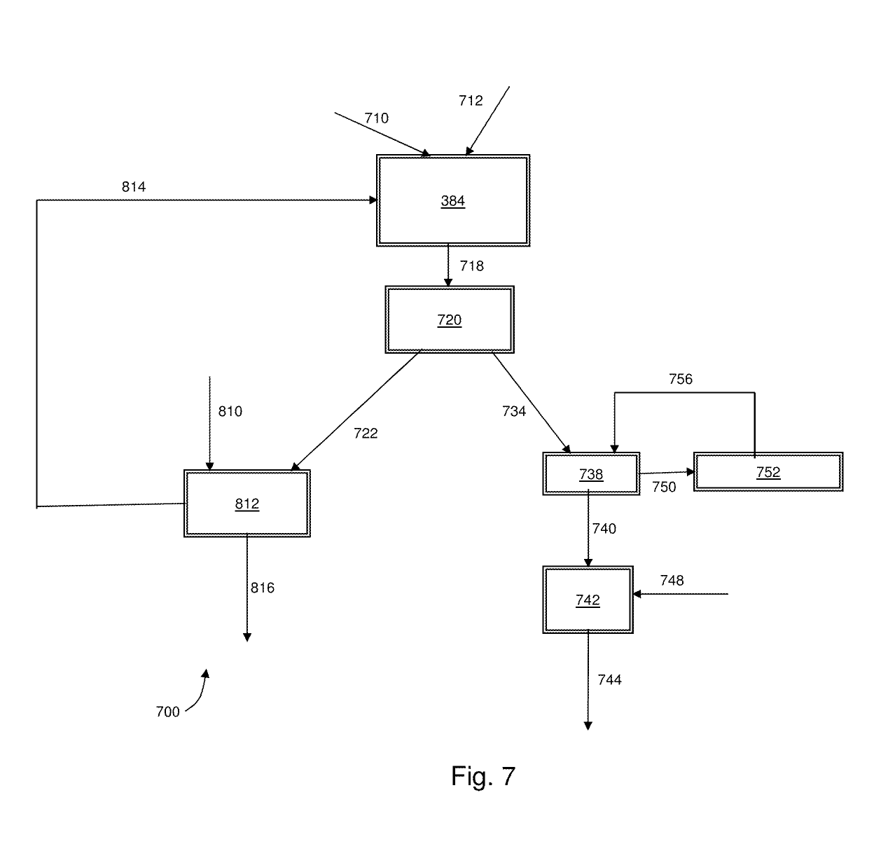

The leaching medium can be used, for example, for leaching of lead from new portions of lead glass until the solution reaches saturation. The saturated leaching medium can be subsequently transported to liquid leaching medium recycling equipment, in which lead ions are recovered from the medium. Lead ions can be recovered in the form of insoluble lead salts, oxides and/or hydroxides, pure metal, etc. For example, lead can be recovered in the form of carbonate, which can be formed when carbon dioxide is bubbled into the leaching medium or by chemical interaction with carbonates, which is shown in FIG. 7; in the form of lead sulfide, for example, when hydrogen sulphide is bubbled into the leaching medium or by chemical interaction with sulphides; or in the form of a lead oxide/hydroxide mixture by caustic precipitation; or in the form of insoluble lead oxalate, for example, when oxalic acid or any of its salts are brought into contact with the lead; or in the form of lead sulfate, for example, by bringing the leaching medium in contact with sulfuric acid and/or any of its salts; or in the form of insoluble lead dithiocarbamate, for example, by bringing the leaching solution in contact with dithiocarbamic acid and/or any of its derivatives, etc.

FIG. 7 is a flowchart illustrating a system 700 in which lead is recovered from the liquid leaching medium in the form of lead carbonate, according to certain embodiments. In FIG. 7, milled lead glass stream 710 and liquid leaching medium stream 712 can be transported to leaching unit 384, which can comprise, for example, a vessel such as a mixer, a flow-through reactor, or any other suitable device in which lead leaching can be carried out. After lead leaching has been performed, the contents of unit 384 can be transported to solid-liquid separator 720 (e.g., a filter) via stream 718. Solid liquid separator 720 can be used to produce stream 722, which can contain leaching solution and stream 734 which can contain treated glass. Stream 722 can be transported to gas-liquid mixer 812. In addition, carbon dioxide can be transported into gas-liquid mixer 812 via stream 810. The carbon dioxide within stream 810 can react with the lead within leaching medium 722 to produce stream 816 containing lead carbonate. After lead has been removed from the leaching medium in stream 722 via gas-liquid mixer 812, the purified leaching medium can be transported back to leaching unit 384 via stream 814.

Residual impurities in glass stream 734 can be removed in rinsing unit 738. Optionally, the liquid used to rinse the glass in stream 734 can be transported to an ion exchange resin in vessel 752 via stream 750, where additional lead and other impurities can be removed. The rinsing liquid (e.g., water) can then be transported back to rinsing unit 738 via stream 756. After the glass within stream 734 has been rinsed, it can be transported from rinsing unit 738 via stream 740 to an optional mixer 742, which can be used to mix additives within stream 748 with the glass prior to transporting the mixed glass and additives out of the system via stream 744. The glass within stream 744 can be used for a variety of applications, as described elsewhere herein.

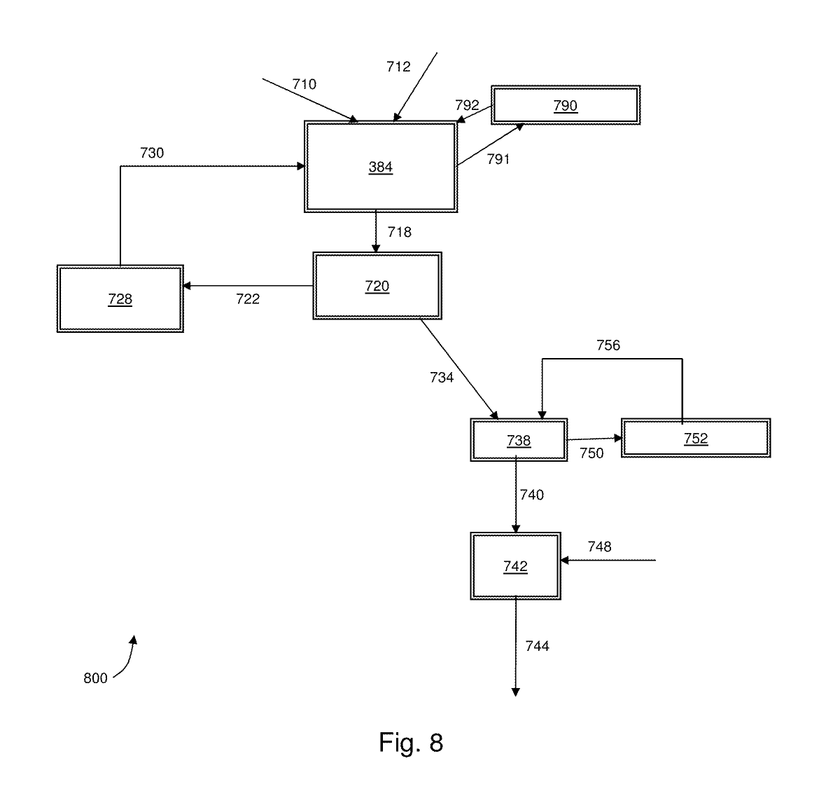

FIG. 8 includes a flow chart of an exemplary lead recovery process 800, based on the absorption of lead using ionic exchange resins. System 800 in FIG. 8 is similar to system 700 of FIG. 7, except that FIG. 8 includes two ion exchange resin stages 728 and 790 in place of gas-liquid mixer 812 in FIG. 7. In FIG. 8, rather than being transported to gas-liquid mixer 810, stream 722 from solid-liquid separator 720 is transported to a vessel 728 containing one or more ion exchange resins. The ion exchange resin can be used to remove lead from the liquid leaching medium, after which, purified liquid leaching medium can be recycled back to leaching unit 384 via stream 730. System 800 also includes optional ion exchange resin container 790, which can be used to treat a slurry of treated glass and liquid leaching medium transported to vessel 790 via stream 791 directly from leaching unit 384. After at least a portion of the lead within the slurry has been removed in vessel 790, the slurry can be transported back to leaching unit 384 via stream 792.

Lead can be recovered in the form of lead acetate, for example, when the leaching medium comprises acetic acid (e.g., when the leaching medium consists essentially of acetic acid), based on the varying solubility of lead in acetic acid at different temperatures. As one particular example, if leaching is performed at elevated temperatures, a portion of lead acetate will crystallize out of the medium when the temperature is reduced below the crystallization limit. Another option for recycling the leaching medium is diffusion dialysis, which can be efficient when using acids that are good electrolytes, such as nitric acid, methanesulfonic acid, etc. Diffusion dialysis can work in parallel with the leaching process. In some embodiments, diffusion dialysis can substantially continuously provide recycled acid at the same time as a flow of concentrated lead salts is generated as an output product (which may be further treated to recover lead in the form of, for example, oxide/hydroxide mixtures or in the form of insoluble lead salts).

Still another option is to recover lead from the leaching medium by subjecting it to an electrowinning procedure. In the electrowinning procedure, lead can be recovered on an electrode (e.g., a cathode) and the leaching medium, depleted of dissolved lead ions, can be re-used in the leaching of the new portion of glass (i.e. recycled). Economically feasible current efficiency and recovery percentages of lead and EDTA can be achieved, for example, if the concentration of chelated Pb(II) is sufficiently high, by using a divided electrowinning cell with a cation exchange membrane. In some such embodiments, EDTA⁴⁻ cannot pass through the membrane, and its oxidation at the anode is prevented. As a result, when lead is recovered on the cathode, the leaching medium will contain substantially all of the EDTA initially present in the leaching medium, so the medium can be re-used for the leaching of new portion of glass. In certain embodiments, the pH of the liquid medium for the lead recovery step is around 2.

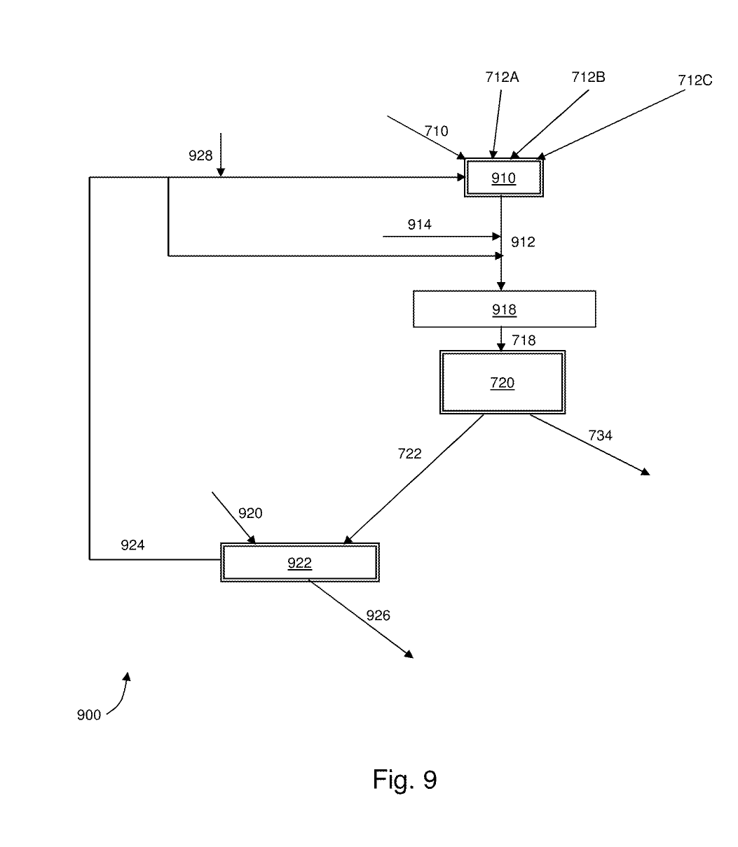

An exemplary process 900 for leaching lead from lead glass using EDTA as a chelating agent and using electrolytic recovery of lead and recycling of the leaching medium is presented in FIG. 9. In FIG. 9, lead-containing glass within stream 710, EDTA within stream 712A, water within stream 712B, and sodium hydroxide within stream 712C can be transported to vessel 910, which can optionally include a mixer. Lead can be reached from the lead containing glass within vessel 910, as described elsewhere herein. In certain embodiments, after the mixture in vessel 910 has formed a taste, the paste can be diluted with water in stream 914 and transported via stream 912 to vessel 918, in which cavitation can be introduced to expedite the lead leaching process, as described elsewhere herein. After leaching has been completed in vessel 918, the resulting mixture can be transported to solid-liquid separator 720 via stream 718. Solid-liquid separator 720 can be used to separate treated glass (which can be transported away from separator 720 via stream 734) from liquid leaching medium (which can be transported away from separator 720 via stream 722).

Liquid leaching medium within stream 722 can be transported to electrowinning device 922, in which lead can be removed from the liquid leaching medium via the electrowinning processes described elsewhere herein. In certain embodiments, acid or base can be transported to electrowinning device 922 via stream 920, which can be used to control the pH of the electrowinning process. Lead removed from the liquid leaching medium can be transported away from the electrowinning process via stream 926. De-leaded liquid leaching medium can be transported away from electrowinning process 922 via stream 924, and optionally transported back to vessel 910 and/or stream 912. In certain embodiments, acid or base can be added to stream 924 via stream 928, which can allow one to control the pH of the recycled liquid leaching medium that is transported back to vessel 910. A similar pH control mechanism can be used to control the pH of the recycled liquid leaching medium that is transported back to stream 912, in certain embodiments.

Another way to recover dissolved metals and EDTA is the iron substitution method, as described, for example, in Kim, C. and Ong, S. K., “Recycling of lead-contaminated EDTA wastewater,” J. Hazard. Mater., B69, 273-286 (1999). Chelated Pb can be replaced by Fe(III), for example, in EDTA chelated complexes because the conditional stability constant of Fe(III)-EDTA complexes is larger than those of Pb-EDTA complexes, and the liberated lead can be precipitated as one of its insoluble salts depending on the type of the iron containing salt, which can be added to introduce ferric ions to the leaching medium. Lead can be precipitated, for example, with PO₄³⁻, SO₄²⁻ or Cl⁻. Ferric ions can be removed from the medium by raising the pH of the medium, as Fe(OH)₃ is more stable than Fe(III)-EDTA complexes. The remaining medium contains EDTA, which can be recovered, for example, by evaporation of water and/or acidification of the medium and separation of solid EDTA in the form of its acid. Subsequently, the acid can be re-used in the preparation of the new portion of the leaching medium or it can be dissolved in NaOH to form sodium EDTA, which can be used in the preparation of the new portion of the leaching medium.

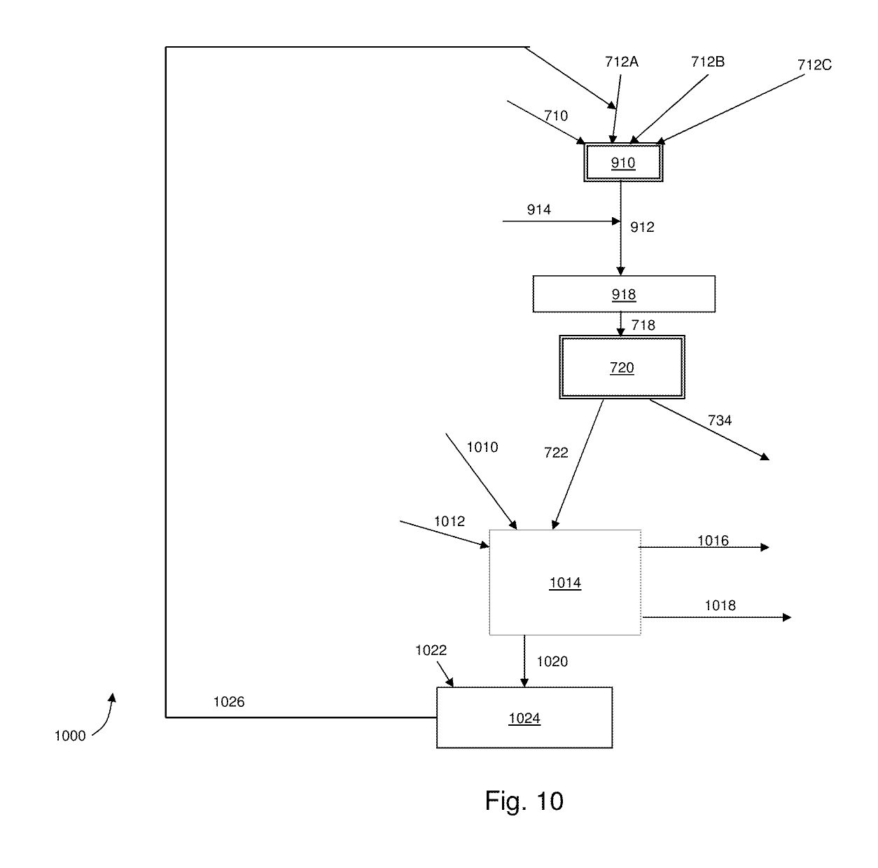

An exemplary process flow of a system 1000 for leaching of lead from lead glass using EDTA as a chelating agent, applying iron substitution for recovery of lead in the form of an insoluble salt and for recovery of EDTA from the spent leaching medium for its reuse in the preparation of the new leaching medium, is presented in FIG. 10. In process 1000, liquid leaching medium 722 from solid-liquid separator 720 can be mixed with a ferric salt within stream 1010 in vessel 1014. In addition, a base (e.g., sodium hydroxide or any other suitable base) can be added to vessel 1014 via stream 1012. The interaction of these components can result in insoluble lead salt leaving vessel 1014 via stream 1016, and ferric hydroxide leaving vessel 1014 via stream 1018. An EDTA-containing solution can exit vessel 1014 via stream 1020. EDTA can be precipitated from stream 1020, for example, by adding acid to and/or by evaporating a liquid component from the EDTA containing solution within vessel 1024. This process can result in deleaded EDTA being produced in stream 1026, which can be recycled to unit 910, for example, directly or via stream 712A.

As was already noted, total or nearly-total lead extraction from the glass can be achieved (e.g., using acids if the size of glass particles is reduced to about 1 micrometer or by using a basic liquid leaching medium and/or a complexing agent such as a chelating agent). Treated lead glass can be analyzed using XRF or by performing EPA Test Procedure 3052 to determine the residual lead content of the treated class. According to EPA Method 3052, the glass sample is completely dissolved in a mixture of hydrofluoric and nitric acid such that there is no residual solid fraction. This results in the substantially complete liberation of all of the lead atoms from the silica structure. The concentration of lead in the medium can be measured using inductively coupled plasma mass spectrometry (ICP-MS), which is known to those of ordinary skill in the art.

Depending on the final application for which the treated glass will be utilized, complete lead removal (and consequently, significant size reduction) may not be necessary as long as the treated glass becomes unleachable (which can happen, for example, both when the lead is completely removed from the bulk of the glass and when lead is removed from the surface portion of the glass to encapsulate the remaining lead inside). Accordingly, in some embodiments, the size of milled glass particles and the optimal remaining lead content can be adjusted to account for the projected use of the treated glass.

The non-leachability of the treated glass may be further assured by the addition of chemical compounds that serve to immobilize lead, such as phosphates, limestone, magnesium oxide, etc. The action of such additives is two-sided: first, they can serving as pH buffers to provide a non-acidic environment, and second, they can work as anion contributors to form insoluble compounds with leached lead cations. In this way, if such compounds (e.g. phosphates) are added, they can serve as a buffer and assure a substantially constant pH, so that lead leaching, which often occurs in acidic conditions, will be inhibited (e.g., will not happen or will happen only to a limited extent). In addition, if such compounds are added, and if lead ions are leached, the lead atoms can be transformed to highly stable mineral pyromorphites, for example, by chemical reaction with phosphates. The so-treated lead glass can be capable of passing not only the standard TCLP test, but also tests developed by the United States Environmental Protection Agency (US EPA) Synthetic Precipitation Leaching Procedure (SPLP), which is designed to simulate 100 years of environmental leaching, and Multiply Extraction Procedure (MEP), which simulates 1000 years of leaching. Methods of reducing the leachability of lead-containing materials are fully described, e.g., in U.S. Pat. No. 5,037,479, which is incorporated herein by reference in its entirety.

The unleaded glass formed according to the systems and methods described herein can find numerous applications as a lead-free product, for example, in the formation of cement preparations, tiles, bricks, foam glass, recycled glass cullet, etc.

According to certain aspects of the present invention, treated glass can be used for production of bricks by the application of a very economic and simple procedure with substantially no heating. In such embodiments, the treated glass is mixed with sodium silicate (e.g., 4-6 wt % of sodium silicate). The mixture can then be distributed in one or more moulds and cured (e.g., in open air). Accelerated curing can occur in the presence of carbon dioxide, which can take as little as several minutes. In this way, bricks or glass agglomerates of any desired shape or size can be produced, which can be further used in the fabrication of a variety of different products.

The present invention is further illustrated with reference to the following examples. The following examples are intended to illustrate certain embodiments of the present invention, but do not exemplify the full scope of the invention.

### Example 1

This example describes the treatment of lead-containing glass with a leaching medium comprising AMBERLITE IRC747, an industrial-grade chelating resin. A mixed CRT glass sample (containing lead funnel and non-lead panel glass) was milled to produce particles with sizes that could be classified as sand. The size distribution of the sample is presented in the Table 4. In Table 4, the “Distribution” corresponds to the percentage of particles with cross sectional diameters smaller than the “Particle Size” listed in the left hand column. For example, 100% of the particles in the glass sample of Table 4 had cross sectional diameters of less than 16 mm, 92% had cross sectional diameters of less than 2 mm, 57% had cross sectional diameters of less than 1 mm, etc. (in Table 4, “Clay” indicates particles <3.90625 microns, “Silt” indicates particles between 3.90625-62.5 microns, “Sand” indicates particles between 62.5 microns-2 mm, and “Gravel” indicates particles between 2-64 mm). The measurement limit for each of the entries in Table 4 was 0.1%.

TABLE 4
Size distribution of mixed CRT glass sample analyzed in Example 1.

| Particle Size | Distribution |
|---|---|
| 16 mm | 100% |
| 8 mm | 100% |
| 4 mm | 100% |
| 2 mm | 92% |
| 1 mm | 57% |
| 0.5 mm | 40% |
| 0.25 mm | 18% |
| 0.12 mm | 9.4% |
| 0.062 mm | 4.0% |
| 0.031 mm | 2.0% |
| 0.016 mm | 1.0% |
| 0.0078 mm | 0.4% |
| 0.0039 mm | 0.3% |
| 0.0020 mm | 0.3% |
| GRAVEL | 7.9% |
| SAND | 88% |
| SILT | 3.7% |
| CLAY | 0.3% |

A leaching medium was prepared by mixing 100 ml of glacial acetic acid with 2000 ml of DI water, which resulted in a pH of 2.4. 60 ml of glass sand were brought into contact with the leaching medium for 1 hour. The leaching medium was sonicated through an opening in the top cover of the leaching vessel. Ultrasonic irradiation was achieved using a 500 W ultrasonic processor with an operational frequency of 20 kHz, attached to a 13 mm diameter horn.

During the leaching process 100 ml of AMBERLITE IRC747 ionic exchange resin (Rohm and Haas) was placed in a mesh bag and immersed in the leaching medium. AMBERLITE IRC747 is an industrial grade chelating resin comprising an aminophosphonic acid (APA) functional group, and can be employed for separation of lead from industrial effluents. After a 1 hour leaching cycle, the lead glass sample was filtered out of the medium using a vacuum filter and repetitively rinsed with 4 portions of rinse water of 500 ml each. Each rinse step was followed by a filtration step. The sample was divided into 2 equal parts: one part was left as is, and the second part was mixed with 10 wt % of magnesium oxide in magnesium hydroxide. TCLP testing was performed on both samples, showing 0.79 mg/L of leachable lead for the part that was not treated with magnesium oxide and less than 0.05 mg/L of leachable lead for the second part that was treated with magnesium oxide. In comparison, TCLP testing revealed that the non-treated glass sample included 126 mg/L of leachable lead.

### Example 2

This example describes the treatment of lead-containing glass with a leaching medium comprising EDTA. In this experiment, the same proportions of glass, acetic acid and DI water were used as were used in the experiments described in Example 1. However, instead of bringing the medium in contact with the ionic exchange resins, 60 ml of disodium EDTA dihydrate was mixed with the medium, resulting in a pH of 3. The sample was indirectly sonicated in a 5 gallon ultrasonic bath, using water within the medium to transfer ultrasonic energy to the sample. The bath was driven by 2000 W of ultrasonic power at 20 kHz. After 1 hour of sonication, the glass sample was filtered out of the leaching medium and rinsed as described in Example 1. The sample was again divided in 2 parts, with one part unmixed (the “as is” sample) and the other part mixed with a mixture of 10 wt % magnesium oxide in magnesium hydroxide. TCLP analysis was performed on both samples. 0.47 mg/L of leachable lead was measured in the “as is” sample and 0.21 mg/L of leachable lead was measured in the sample mixed with the mixture of magnesium oxide and magnesium hydroxide.

### Example 3

The same leaching procedure was applied to the same sort of glass as described in Examples 1 and 2, keeping the same ratios of acid:water and acid:EDTA as described in Example 2. In this example, the solid:liquid ratio was varied. TCLP analysis was performed on all samples. The leaching medium, including the leached lead, was sampled and analysed by ICP-MS. The results are presented in Table 5. As illustrated, decreasing the amount of liquid relative to the amount of solid produced a leaching medium including a higher concentration of lead ions. In addition satisfactory TCLP results were achieved using leaching media with relatively large amounts of solid relative to the amount of liquid, which are generally more economical to use.

TABLE 5
Experimental results for mixed CRT glass sample analyzed in Example 3.

| | acid:water, | acid:EDTA, | solid:liquid, | admixtures, | TCLP, | Pb in leaching |
|---|---|---|---|---|---|---|
| N | by volume | by volume | by volume | wt % | mg/L | medium, mg/L |
| 1 | 1:20 | 5:3 | 3:100 | 0 | 0.47 | 227 |
| 2 | 1:20 | 5:3 | 3:100 | 10 | 0.21 | 227 |
| 3 | 1:20 | 5:3 | 6:100 | 0 | 0.35 | 415 |
| 4 | 1:20 | 5:3 | 6:100 | 10 | <0.05 | 415 |
| 5 | 1:20 | 5:3 | 1:10 | 0 | 0.32 | 748 |
| 6 | 1:20 | 5:3 | 1:10 | 10 | <0.05 | 748 |

### Example 4

In the next series of experiments, the amount of EDTA was increased compared to previous examples. In addition, the solid:liquid ratio was varied. A funnel CRT glass sample initially including 62.8 mg/L of leachable lead (measured using TCLP analysis) was treated as described in Examples 1-3. Table 6 includes a summary of the experimental results. As in the previous examples, an almost linear dependence of the amount of leached lead on the solid:liquid ratio of the sample was observed.

TABLE 6
Experimental results for CRT funnel glass sample analyzed in Example 4.

| | acid:water, | acid:EDTA, | solid:liquid, | admixtures, | TCLP, | Pb in leaching |
|---|---|---|---|---|---|---|
| N | by volume | by volume, pH | by volume | wt % | mg/L | medium, mg/L |
| 1 | 1:20 | 5:8, pH = 3.2 | 7:100 | 0 | 0.38 | 417 |
| 2 | 1:20 | 5:8, pH = 3.2 | 7:100 | 10 | <0.05 | 417 |
| 3 | 1:20 | 5:16, pH = 3.4 | 14:100 | 0 | 0.73 | 835 |
| 4 | 1:20 | 5:16, pH = 3.4 | 14:100 | 10 | 0.20 | 835 |

### Example 5

A large chunk of CRT glass, containing a piece of funnel glass and a piece of panel glass, attached by the frit line, was selected for the experiment. A leaching medium containing 10% by volume of glacial acetic acid was prepared. The piece of glass was immersed in the medium for 48 hours. Pieces of funnel and panel glass disconnected and fell apart as the frit line was dissolved. Lead oxide made up about 70% of the weight of the frit line. Dissolution of lead oxide caused the frit line to disappear, leaving an undissolved powdered substance on the bottom. It is believed that the powdered substance was silica oxide, which makes up part of the frit line composition and is generally insoluble in the leaching medium. This observation may be helpful when applied to the separation of large pieces of CRT glass containing both funnel and panel glass pieces, which are connected by a frit line, or for the separation of panel and funnel parts of whole CRTs. As soon as the frit line is dissolved, pieces of glass can be physically separated and may be forwarded to, for example, an optical sorter for separation of leaded and non-leaded glass.

### Example 6

CRT funnel glass was ground in a laboratory ball mill down to d₉₅=35.41 micrometers, and the so obtained glass powder was sieved to remove particles smaller than 20 microns. The resulting mixture of glass particles had the size distribution shown in Table 7.

TABLE 7
Size distribution of the glass powder used in Example 6.

| Diameter | Microns |
|---|---|
| d₁₀ | 1.103 |
| d₂₀ | 1.647 |
| d₃₀ | 2.632 |
| d₄₀ | 3.931 |
| d₅₀ | 5.680 |
| d₆₀ | 7.943 |
| d₇₀ | 10.53 |
| d₈₀ | 13.48 |
| d₉₀ | 17.50 |
| d₉₅ | 21.03 |

5 g of this untreated glass was sent to an external laboratory for EPA 3052 analysis, which showed the presence of 20.3 wt % of lead (Pb) (or 21.9 wt % of lead oxide PbO) in the glass.

25 g of the glass was mixed with 35 g of disodium EDTA dihydrate, 300 ml of water and 35 ml of 10M NaOH solution. The mixture was heated to 85° C. and agitated at low speed for 4 hours. The pH of the solution during mixing was around 10.5, varying slightly. At the end of mixing, the solid fraction looked like a gelatinous paste. 500 ml of boiling water was added to the paste to dissolve it and the resulting solution was sonicated using an ultrasonic horn (750 W, Sonics & Materials) at 45% power for 5 min. Subsequently, the mixture was centrifuged for 10 min until a hard cake was obtained, and the liquid fraction was collected. 500 ml of boiling water was added to the solid cake, and the resulting slurry was mixed and sonicated for 5 min. Next, the resulting mixture was centrifuged and another batch of leaching liquid was added to the glass portion. The procedure outlined above was repeated 2 more times and the resulting volume of the leaching medium was 2154 ml. The cake was left to dry in open air, and the final weight of cake was 16 g. It is believed that the final weight of the cake was less than the starting weight of the glass particles due to mechanical losses during treatment.

5 g of treated glass was sent to an external laboratory for EPA 3052 analysis, which showed presence of 3.51 wt % of lead (Pb) (or 3.78 wt % of lead oxide PbO) in the glass. The initial lead content of the sample was 20.3 wt %. Accordingly, 88.9% (or 4.51 g) of the lead in the original glass sample (including lead present both at the surface of the glass particles as well as lead present within the bulk of the glass particles) was removed from the sample by this treatment process.

The leaching medium was analyzed by ICP-MS and showed concentration of lead 1905 mg/L. Considering the volume of recovered leaching medium, the total lead recovery was 4.10 g or 80.85%. The quantity of lead removed from the sample according to solids analysis (which was 4.51 g), was very close to the value obtained by the analysis of leaching liquid (4.10 g), indicating a relatively consistent mass balance.

### Example 7

25 g of the glass described in Example 6 was mixed with 35 g of disodium EDTA dihydrate, 250 ml of water, and 60 ml of 10M NaOH solution. The mixture was heated to 85° C. and agitated at low speeds for 4 hours to form a paste. 500 ml of boiling water was added to the paste to dissolve it and the resulting solution was sonicated at 45% power for 5 min. Subsequently, the mixture was centrifuged for 10 min until a hard cake was formed, and the liquid fraction was collected. The final pH of the leaching medium was 13.5. The volume of the leaching medium was 494 ml, and the measured lead concentration in it was 7170 mg/L. The lead content in the untreated glass was 20.3 wt %. Accordingly, 88.7% of the lead originally present in the untreated glass was removed in this experiment.

### Example 8

25 g of the glass described in Example 6 was mixed with 35 g of disodium EDTA dihydrate, 250 ml of water, and 80 ml of 10M NaOH solution. The mixture was heated to 100° C. and agitated at low speed for 2 hours. No cover was present on the beaker, meaning that the water was able to evaporate. Paste formation was observed at the end of the 2^{nd} hour. The agitation was stopped, and 500 ml of boiling water was added to the paste to dissolve it. The resulting solution was sonicated at 45% power for 5 min. Subsequently, the mixture was centrifuged for 10 min until a hard cake was formed, and the liquid fraction was collected. The final pH of the leaching medium was 11.8, and the volume of the collected leaching medium was 558 ml. The liquid sample was analyzed by ICP-MS. When the sample was acidified according to the regular procedure (i.e. before passing the sample to ICP it was diluted with 2% solution of nitric acid), the solid precipitate of 9.49 g was formed in a sample having a volume of 40 ml.

The solid precipitate was filtered and leached with nitric acid until it was completely dissolved. The concentration of lead in the dissolved sample was 5850 mg/kg. The concentration of lead in the liquid sample was 6830 mg/L. The lead content in the original untreated glass was 20.3 wt %. Accordingly, 90.4% of the lead in the original untreated glass was removed in this experiment.

### Example 9

This example demonstrates the dependence of the quantity of the extracted lead on the size of glass particles. Glass powder with the size distribution shown in Table 8 was sieved to obtain a first fraction containing particles with diameters of 50-106 micrometers and a second fraction containing particles with diameters of 106-315 micrometers.

25 g of the 50-106 micrometer fraction was mixed with 35 g of disodium EDTA dihydrate, 250 ml of water, and 80 ml of 10M NaOH solution. The mixture was heated to 100° C. and agitated at low speed for 1.5 hrs until a gelatinous paste was formed. The agitation was stopped, and 500 ml of boiling water was added to the paste to dissolve it. The resulting solution was sonicated at 45% power for 5 min. Subsequently, the mixture was centrifuged for 10 min until a hard cake was formed, and the liquid fraction was collected. The final pH of the leaching medium was 12.1, and the volume of the collected leaching medium was 592 ml. The concentration of lead in the liquid sample was 2560 mg/L. The lead content in the untreated glass was 20.3 wt %. Accordingly, 29.9% of the lead in the untreated glass was removed in this experiment.

25 g of the 106-315 micron fraction was mixed with 35 g of disodium EDTA dihydrate, 250 ml of water, and 80 ml of 10M NaOH solution. The mixture was heated to 100° C. and agitated at low speed for 1.5 hrs, but the formation of paste was not observed. The agitation was stopped and 500 ml of boiling water was added to the mixture to dissolve it. The resulting solution was sonicated at 45% power for 5 min. Subsequently, the mixture was centrifuged for 13 min, but the cake was very weak, so the centrifuging was continued for an additional 10 min. In addition, more boiling water was added to remove all of the residues. The final volume of the collected leaching medium was 940 ml. The liquid sample was analyzed by ICP-MS, and when the sample was acidified according to the regular procedure, 5.222 g of solid precipitate was formed in a 44.4 ml sample volume. The solid precipitate was filtered out and leached with nitric acid until it was completely dissolved. The concentration of lead in the dissolved sample was 586 mg/kg. The concentration of lead in the liquid sample was 597 mg/L. Considering the initial lead content in the untreated glass was 20.3 wt %, 12.3% of lead removal was achieved in this experiment.

TABLE 8
Size distribution of the glass powder used in the experiment.

| Diameter | Microns |
|---|---|
| d₁₀ | 4.815 |
| d₂₀ | 13.16 |
| d₃₀ | 23.71 |
| d₄₀ | 35.83 |
| d₅₀ | 50.84 |
| d₆₀ | 75.05 |
| d₇₀ | 108.7 |
| d₈₀ | 140.9 |
| d₉₀ | 186.0 |
| d₉₅ | 237.2 |

### Example 10

This example describes various ways in which lead can be recovered from the leaching medium after the lead has been removed from lead-containing glass, and ways in which the leaching medium can be recycled for subsequent use. The experiments described in this example make use of the leaching medium described in Example 6.

In a first set of experiments, 1 ml of concentrated sulphuric acid was added to 100 ml of the leaching medium (having a lead concentration of 1905 mg/L, to drop the pH of the medium from 13.2 to 0.6. The leaching medium acquired a milky color and lost transparency almost immediately. The solid precipitate was allowed to settle, and the leaching solution was analyzed for lead content. It was determined that the leaching medium contained lead in a concentration of 22.9 mg/L, showing that the precipitate contained almost all of the lead initially dissolved in the liquid sample.

A second set of experiments investigated the recovery of lead via electrowinning. In this set of experiments, acid was added to the initially basic leaching medium without allowing the lead to precipitate. Good electrical conductivity of the solution is generally advantageous for electrowinning. Accordingly, methanesulphonic acid, which is a very good electrolyte, was used for acidification. 1.5 ml of 70% methanesulphonic acid was added to 100 ml of the leaching medium (having a lead concentration of 1905 mg/L), reducing the pH from 13.2 to 2.8. The lead content of the resulting solution was 2010 mg/L. This experiment demonstrated that it would be possible to lower the pH of the leaching medium without forming a substantial amount of precipitates so that the medium can be used for electrowinning of lead.

Another potential method for recovering chelated metals involves iron substitution. For example, ferric sulphate can be added to a solution containing chelated metals to recover the chelated metal. Fe-EDTA bonds are more stable than Pb-EDTA bonds. Accordingly, when iron is added to a medium containing EDTA-chelated lead, iron replaces the lead in the EDTA chelating complex, and lead precipitates from the leaching medium in the form of lead sulphate. A sample of the leaching medium containing 1750 mg/L of dissolved lead was mixed with the excess of ferric sulphate and stirred for one hour at room temperature. A solid precipitate was formed and was filtered out. The leaching medium was then analyzed for lead content, showing 12.8 mg/L of residual lead. This experiment demonstrates lead may be recovered from these solutions by iron substitution.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of extracting lead from a lead-containing glass, comprising:
exposing a plurality of lead-containing glass particles to a liquid leaching medium comprising a lead-complexing agent, such that the lead-complexing agent associates with at least a portion of the lead from within the bulk of the lead-containing glass to facilitate transport of the lead to the liquid leaching medium to produce treated glass; and
separating at least a portion of the treated glass particles from at least a portion of the liquid leaching medium,
wherein, throughout the exposing step, at least about 50% of the total volume of the glass particles is made up of glass particles having a minimum cross-sectional dimension of at least about 2 micrometers.

2. (canceled)

3. The method of claim 1, wherein the lead-complexing agent comprises a chelating agent, such that during the exposing step, the chelating agent contacts at least a portion of the lead within the bulk of the lead-containing glass to form a chelate, and at least a portion of the chelate is transferred from the bulk of the glass to the liquid leaching medium to produce the treated glass particles.

4. A method of extracting lead from lead-containing glass, comprising:
exposing the lead-containing glass to a liquid leaching medium comprising a lead-complexing agent, wherein the liquid leaching medium has a pH of at least about 8;
transporting at least a portion of the lead from within the bulk of the lead-containing glass to the liquid leaching medium to produce treated glass; and
separating at least a portion of the treated glass from at least a portion of the liquid leaching medium.

5. (canceled)

6. The method of claim 1, wherein the lead-containing glass, prior to exposure to the liquid leaching medium, contains lead oxide in an amount of at least about 2 wt %.

7-8. (canceled)

9. The method of claim 1, wherein the lead-containing glass, prior to exposure to the liquid leaching medium, contains lead oxide in an amount of at least about 20 wt %.

10. The method of claim 1, wherein the liquid leaching medium has a pH of at least about 8.

11. The method of claim 10, wherein the liquid leaching medium has a pH of from about 10 to about 14.

12. The method of claim 1, wherein the liquid leaching medium removes at least a portion of the lead that is at least 1 micrometer deep relative to the exterior surface of the glass.

13-18. (canceled)

19. The method of claim 1, wherein, after treatment, the glass contains lead oxide in an amount of less than about 50 wt %.

20-22. (canceled)

23. The method of claim 1, wherein, after treatment, the glass contains lead oxide in an amount of less than about 0.1 wt %.

24. The method of claim 1, wherein at least about 2% of the lead that is originally contained within the lead-containing glass is removed from the lead-containing glass during exposure to the liquid leaching medium.

25-30. (canceled)

31. The method of claim 1, wherein at least about 99% of the lead that is originally contained within the lead-containing glass is removed from the lead-containing glass during exposure to the liquid leaching medium.

32. The method of claim 1, wherein substantially all of the lead that is originally contained within the lead-containing glass is removed from the lead-containing glass during exposure to the liquid leaching medium.

33. The method of claim 32, wherein substantially all of the lead within the lead-containing glass is removed from the lead-containing glass within 24 hours.

34. (canceled)

35. The method of claim 1, comprising creating cavitation within the liquid leaching medium during at least a portion of the time during which the lead-containing glass is exposed to the liquid leaching medium.

36. The method of claim 5, wherein the cavitation is produced by exposing the liquid leaching medium to ultrasonic waves.

37. The method of claim 36, wherein the ultrasonic waves have a frequency of at least about 20 kHz.

38. (canceled)

39. The method of claim 3, wherein the chelating agent comprises a phosphonic acid derivative.

40. The method of claim 3, wherein the chelating agent comprises ethylenediaminetetraacetic acid (EDTA).

41-43. (canceled)

44. An integrated system configured for recycling electronic equipment comprising leaded glass, comprising:
a first stage in which a substantially intact piece of electronic equipment comprising glass components and non-glass components is disaggregated to produce glass components and non-glass components;
a second stage in which at least a portion of the glass components are separated from at least a portion of the non-glass components, wherein at least a portion of the glass components comprise lead-containing glass; and
a third stage comprising a liquid leaching medium able to extract at least a portion of the lead from the lead-containing glass.

45-51. (canceled)
